(19) United States
(12) Patent Application Publication
(10) Pub. No.: US 2022/0147889 A1
(43) Pub. Date: May 12, 2022

(54) DEVICE, SYSTEM AND METHOD FOR ASSESSING WORKER RISK

(71) Applicant: Makusafe Corp., West Des Moines, IA (US)

(72) Inventors: Mark Frederick, Cumming, IA (US); Gabriel Glynn, Ankeny, IA (US); Matt McMullen, West Des Moines, IA (US)

(21) Appl. No.: 17/518,644

(22) Filed: Nov. 4, 2021

Related U.S. Application Data
(60) Provisional application No. 63/110,565, filed on Nov. 6, 2020.

(51) Int. Cl. G06Q 10/06

(52) U.S. Cl. CPC G06Q 10/0635; G06Q 10/06398

(57) ABSTRACT

A system and method for evaluating safety risk of workers is presented. The system includes wearable devices configured to be attached to or carried by workers during a work shift. The wearable device includes sensors configured to gather information indicative of working conditions and work performed by workers. The wearable device records information that is gathered by sensors. A monitoring system is configured to receive and store the information recorded by the wearable devices. A management system is communicatively connected to the monitoring system. The management system is configured to assess risk faced by workers based on the recorded information stored in the monitoring system.

### CROSS REFERENCE TO RELATED APPLICATIONS

This application claims priority to U.S. Provisional Patent Application. 63/110,656 filed on Nov. 6, 2020 and titled “DEVICE, SYSTEM AND METHOD FOR ASSESSING WORKER RISK AND DETERMINING POLICY PREMIUMS”, the entirety of which is hereby fully incorporated by reference herein.

This application is related to U.S. Pub. No. 2021/0264764 filed May 6, 2021 and titled DEVICE, SYSTEM AND METHOD FOR HEALTH AND SAFETY MONITORING; U.S. Pat. No. 11,030,875, filed on Nov. 20, 2019 and titled SAFETY DEVICE, SYSTEM AND METHOD OF USE; U.S. Pat. No. 10,522,024 filed on Sep. 7, 2018 and titled SAFETY DEVICE, SYSTEM AND METHOD OF USE; and U.S. Pat. No. 10,096,230 filed on Jun. 6, 2017 and titled SAFETY DEVICE, SYSTEM AND METHOD OF USE, each of which is hereby incorporated by reference herein in its entirety, including any figures, tables, or drawings or other information.

### FIELD OF THE DISCLOSURE

This disclosure generally relates to monitoring systems. More specifically and without limitation, this disclosure relates to a monitoring system utilizing wearable devices to gather information indicative of work and analyze risk posed to workers by the work.

### OVERVIEW OF THE DISCLOSURE

Injuries at work are tremendously costly for both the corporation as well as the injured worker. As an example, it is estimated that 2016 will again see nearly 100 billion dollars in workers' compensation claims. It is estimated that the average claim in the United State in 2016 will amount to over $100,000.

Most, if not all of these work-related injuries are avoidable. In view of the personal cost to the injured worker and the financial cost to the employer, a great amount of energy and effort has been placed on avoiding workplace injuries. Many employers have implemented various systems to avoid accidents ranging from common sense solutions to sophisticated systems, from establishing safety teams and safety managers to hiring third-party safety auditors, and everything in-between. However, despite these many efforts, avoidable injuries continue to occur at an alarming pace.

Employers are generally required to carry workers' compensation insurance to provide compensation to workers for injuries incurred on the job. Typically, premiums charged by insurers is calculated based on payroll of workers, the type work performed by workers (e.g., per industry type and/or job classification), and the companies claims experience for previous injuries.

Typically, a workers' compensation policy charges an upfront premium for a year that's based on an estimated risk. At the end of the year, an audit is conducted to make sure the policy holder's premium price is fair. The auditor compares the actual payroll amounts to the premium being charged. The auditor will also double-check that workers were classified correctly. Based on the audit, the policy holder may be required to pay more or possibly receive a refund.

Due to the complex nature of today's modern manufacturing facility and work environments generally, it is difficult to accurately assess risk of injury based on broad classification of a workers' primary and secondary duties into a single class. For example, it is recognized that various secondary duties and/or tasks performed by a worker 102 may pose a different risk than the worker's primary occupational role. As an illustrative example, receptionist may generally be a low risk occupation. However, a receptionist may perform secondary responsibilities that require the receptionist move through area where there is a higher risk of injury. This complexity of assessing true risk posed by workers over an entire work shift is a difficult if not impossible task.

Therefore, there is a need in the art to provide a device, system and method of use for collecting, reporting and analyzing information indicative of work performed by workers and workplace to better assess risk posed to workers during an entire work shift.

Thus, it is a primary object of the disclosure to provide a wearable device, system and method of use that improves upon the state of the art.

Another object of the disclosure is to provide a wearable device, system and method of use that collects information about the work performed by workers and workplace conditions.

Yet another object of the disclosure is to provide a wearable device, system and method of use that utilizes collected information to assess safety risks faced during a work shift.

Another object of the disclosure is to provide a wearable device, system and method of use that aggregates a great amount of information about the work performed by workers and workplace conditions.

Yet another object of the disclosure is to provide a wearable device, system and method of use that eliminates bias in the collection of information about the work performed by workers and workplace conditions.

Another object of the disclosure is to provide a wearable device, system and method of use that eliminates the inconsistency in reporting information about the work performed by workers and workplace conditions.

Yet another object of the disclosure is to provide a wearable device, system and method of use that analyzes data gathered to assess risk posed to workers at multiple times throughout a work shift.

Another object of the disclosure is to provide a wearable device, system and method that more accurately assesses risk during a work shift.

Yet another object of the disclosure is to provide a wearable device, system and method of use that determines insurance premium based on accumulated data indicative of work performed by workers and workplace conditions.

Another object of the disclosure is to provide a wearable device, system and method of use that aggregates a great amount of information indicative of work performed by workers and workplace conditions to facilitate data analytics.

Yet another object of the disclosure is to provide a wearable device, system and method of use that assesses gathered data indicative of work performed by workers and workplace conditions to facilitate assessment of safety risks faced by workers during a work shift.

Another object of the disclosure is to provide a wearable device, system and method of use that assesses gathered data indicative of work performed by workers and workplace conditions to facilitate determination of work workers' compensation policy premiums Yet another object of the disclosure is to provide a wearable device, system and method of use that assesses gathered data indicative of work performed by workers and workplace conditions to facilitate end of year auditing of a workers' compensation policy.

Another object of the disclosure is to provide a wearable device, system and method of use that gathers information indicative of work performed by workers and workplace conditions without substantially inconveniencing workers.

Yet another object of the disclosure is to provide a wearable device, system and method of use that is cost effective.

Another object of the disclosure is to provide a wearable device, system and method of use that is safe to use.

Yet another object of the disclosure is to provide a wearable device, system and method of use that is easy to use.

Another object of the disclosure is to provide a wearable device, system and method of use that is efficient to use.

Yet another object of the disclosure is to provide a wearable device, system and method of use that is durable.

Another object of the disclosure is to provide a wearable device, system and method of use that is robust.

Yet another object of the disclosure is to provide a wearable device, system and method of use that can be used with a wide variety of manufacturing facilities.

Another object of the disclosure is to provide a wearable device, system and method of use that is high quality.

Yet another object of the disclosure is to provide a wearable device, system and method of use that has a long useful life.

Another object of the disclosure is to provide a wearable device, system and method of use that can be used with a wide variety of occupations.

Yet another object of the disclosure is to provide a wearable device, system and method of use that provides high quality data.

Another object of the disclosure is to provide a wearable device, system and method of use that provides data and information that can be relied upon.

Yet another object of the disclosure is to provide a wearable device, system and method of use that allows for companies to compare the safety of their facilities to other facilities inside the same company and outside the company to determine how safe their facilities are in comparison.

Another object of the disclosure is to provide a system wearable device, system and method of use that monitors physical exertion exhibited by workers during a work shift.

These and countless other objects, features, or advantages of the present disclosure will become apparent from the specification, figures, and claims.

### SUMMARY OF THE DISCLOSURE

In one or more arrangements, a system and method for evaluating safety risk and calculating insurance premiums is presented. In one or more arrangements, the system includes wearable devices configured to be worn by workers during a work shift. The wearable devices have a power source, a wireless communication module and one or more sensors. The sensors are configured to monitor environmental data, biometric data, accelerometer and motion data, location and/or other data indicative of working conditions and/or work performed by the workers. The wearable device records information gathered by the sensors. A monitoring system is configured to receive and store the information recorded by the wearable devices. A policy management system is communicatively connected to the monitoring system. The policy management system is configured to determine insurance premiums for the workers based on the recorded information stored in the monitoring system.

In one or more arrangements, the wearable device is configured to record the information from a plurality of time periods of the work shift. The policy management system configured to determine insurance premiums for the workers based on the information from a full work shift including information recorded from each of the plurality of time periods.

In one or more arrangements, monitoring system includes a database and a data processing system communicatively connected to the database. The database is configured to receive and store the data from the one or more sensors recorded by the wearable device. The data processing system is configured to perform one or more data analytics processes to identify safety risks faced by the worker during the work shift.

In one or more arrangements, the monitoring system and/or the policy management system are configured to perform data analytics on the stored recorded information to derive various data metrics indicative of safety risks faced by workers during the work shift. For example, in some various arrangements, the data analytics may safety risks to the workers; classify the type of work performed by workers; identify deviations in work performed by groups of workers having the same primary occupational role; evaluate location data to identify higher risk areas and lower risk areas of a workplace; identify risks faced by individual workers based on location of the workers and the identified higher risk areas and lower risk areas; identify accidents, trips, falls, or near misses and other high risk events that occur during the work shift of the worker; identify repetitive motions that may pose a higher risk of injury; assess physicality of work performed by the workers; and/or identify jobs requiring high degree of physicality which pose a higher risk of injury.

In one or more arrangements, the data gathered by the sensors is aggregated in a database for data mining purposes so as to facilitate assessment of risk of worker injury. In one or more arrangements, the system is configured to characterize a profiles of different occupations and identify when data gathered by a wearable sensor for a worker deviates from the profile for their indicated occupation.

### BRIEF DESCRIPTION OF THE DRAWINGS

FIG. 1 is a plan view of a wearable device for use in a system for assessing safety risks of workers and determining policy premiums, in accordance with one or more embodiments, the wearable device having a housing or core, an attachment member, at least one microprocessor, at least one memory, a receiver and/or transceiver, an antenna, a power source, a port, an audible indicator, a visual indicator, a physical indicator, an ID, and a plurality of sensors including sound sensors, temperature sensors, humidity sensors, light sensors, air quality sensors, CO censors, position sensors and an accelerometer, to name a few, the wearable device also includes an event trigger; the wearable device is included as part of a system configured to facilitates the collection and analyzation of worker activities and movements and facilitates the detection, tracking, identification and response to accidents, near misses and notable events or suggestions.

FIG. 2 is a plan view of a system using the wearable device described in FIG. 1 for collection of information, the view showing a plurality of wearable devices, each assigned to a worker; the view showing these wearable devices in communication with the database, electronic network and management software; the view showing information from the wearable devices flowing to a safety manager for the safety manager's attention to the information provided by the wearable devices including to accidents, near misses and notable events or suggestions.

FIG. 3 is a plan view of the system described in FIG. 2, the view showing a wearable device in electronic communication with the components of the system including a database, data processing system, user interface, management software, data analytics processes and policy management software, the view also showing the wearable device in communication with a safety manager and/or in communication with the electronic device of a safety manager.

FIG. 4 is an elevation view of one configuration of a wearable device, the view showing a core having a generally circular peripheral shape, the view showing the wearable device having an event trigger, a plurality of sensors, and a plurality of visual indicators.

FIG. 5 is a perspective view of another configuration of a wearable device, the view showing the wearable device having an elongated core having an upper end, lower end, opposing sides, a forward wall, a back wall, and opposing end walls, the wearable device having an event trigger positioned within its forward wall, and a visual indicator positioned in its upper end wall; the view showing the core sized and shaped to fit within an opening of a holster, the holster having a back wall and a pair of side walls and a step that are configured to receive and hold the core therein; the view showing the holster connected to an attachment device that is in the form of a band that is configured to fit around the wrist or arm of a worker; the view showing the core about to be inserted within the opening of the holster.

FIG. 6 is a perspective view of the system shown in FIG. 5, the view showing the core fully inserted within the opening of the holster; the view also showing an opening in the upper end of the core to provide access to sensors housed within the hollow interior of the core.

FIG. 7 is another perspective view of the system shown in FIGS. 5 and 6, the view showing the core fully inserted within the opening of the holster; the view also showing an opening in the upper end of the core to provide access to sensors housed within the hollow interior of the core.

FIG. 8 is an elevation view of the front side of the system shown in FIGS. 5 through 7, the view showing the core fully inserted within the opening of the holster.

FIG. 9 is an elevation view of the front side of the system shown in FIGS. 5 through 8, the view showing the core fully inserted within the opening of the holster; the view showing the band removed.

FIG. 9A is an elevation view of the top side of the system shown in FIGS. 5 through 9, the view showing the core fully inserted within the opening of the holster; the view showing the band removed; the view showing a light pipe positioned in the core that provides access for light in the environment to be sensed by a light sensor; the view also showing a plurality of openings in the core that provides access to other sensors in the core, such as a sound sensor and an air quality sensor, or the like.

FIG. 9B is an elevation view of the bottom side of the system shown in FIGS. 5 through 9, the view showing the core fully inserted within the opening of the holster; the view showing the band removed.

FIG. 9C is an elevation view of the left side of the system shown in FIGS. 5 through 9, the view showing the core fully inserted within the opening of the holster; the view showing the band removed.

FIG. 9D is an elevation view of the right side of the system shown in FIGS. 5 through 9, the view showing the core fully inserted within the opening of the holster; the view showing the band removed.

FIG. 10 is another perspective view of the system shown in FIGS. 5 through 9, the view showing the core fully inserted within the opening of the holster; the view showing the band removed.

FIG. 11 is another perspective view of the system shown in FIGS. 5 through 10, the view showing the core fully inserted within the opening of the holster; the view showing the band removed.

FIG. 12 is another perspective view of the system shown in FIGS. 5 through 11, the view showing the core fully inserted within the opening of the holster; the view showing the band removed; the view showing the back side of the holster.

FIG. 13 is a partial perspective view of the holster of the system, the view showing the opening in the holster between opposing sidewalls and the back wall that is sized and shaped to receive the core therein; the view also showing the detent mechanism in the back wall that is configured to engage the core and hold the core within the opening of the holster; the view also showing the step positioned in the lower end of the back wall between the sidewalls that is configured to engage the lower end of the core and prevent the core from sliding out the lower end of the opening.

FIG. 14 is a partial perspective view of the back side of the lower end of the core, the view showing the detent mechanism in the back wall that is configured to engage the detent mechanism in the holster and hold the core within the opening of the holster; the view also showing the step positioned in the lower end of the back wall between the sidewalls that is configured to engage the lower end of the opening of the holster and prevent the core from sliding out the lower end of the opening; the view also showing the port with a plurality of connection pins positioned in the lower end of the back wall at the step, the port configured to provide charging capabilities as well as data transfer capabilities when plugged into the charging base or other components of the system.

FIG. 15 is a front view of a charging base of the system; the view showing the charging base having a back wall and a lower wall, the back wall having a plurality of sockets that are sized and shaped to receive cores therein such that once the cores are plugged into the charging base the cores are charged as well as data transfer occurs between the charging base (and the other components of the system) and the core; the view also showing a user interface positioned in the lower wall of the charging base, the user interface allows a worker 102 to interact with the charging base, such as scanning in or typing in their user information so as to facilitate the allocation of a core to the worker; the view showing a plurality of sockets occupied by cores and a plurality of sockets unoccupied by cores.

FIG. 16 is a left side view of a charging base shown in FIG. 15; the view showing the charging base having a back wall and a lower wall, the back wall having a plurality of sockets that are sized and shaped to receive cores therein such that once the cores are plugged into the charging base the cores are charged as well as data transfer occurs between the charging base (and the other components of the system) and the core; the view also showing a user interface positioned in the lower wall of the charging base, the user interface allows a worker 102 to interact with the charging base, such as scanning in or typing in their user information so as to facilitate the allocation of a core to the worker.

FIG. 17 is a perspective view of a charging base shown in FIGS. 15 and 16; the view showing the charging base having a back wall and a lower wall, the back wall having a plurality of sockets that are sized and shaped to receive cores therein such that once the cores are plugged into the charging base the cores are charged as well as data transfer occurs between the charging base (and the other components of the system) and the core; the view also showing a user interface positioned in the lower wall of the charging base, the user interface allows a worker 102 to interact with the charging base, such as scanning in or typing in their user information so as to facilitate the allocation of a core to the worker; the view showing a plurality of sockets occupied by cores and a plurality of sockets unoccupied by cores.

FIG. 18 is a plan view of a system for assessing safety risks of workers and determining policy premiums, in accordance with one or more embodiments; the view showing wearable devices, a monitoring system, and a policy management system, the view showing the monitoring system and policy management system implemented separately.

FIG. 19 is a plan view of a system for assessing safety risks of workers and determining policy premiums, in accordance with one or more embodiments; the view showing wearable devices, a monitoring system, and a policy management system, the view showing the monitoring system and policy management system implemented together.

FIG. 20 is a plan view of a system for assessing safety risks of workers and determining policy premiums, in accordance with one or more embodiments; the view showing wearable devices, a monitoring systems, and a policy management system, the view showing the policy management system communicatively connected to monitoring systems of two companies.

FIG. 21 shows a flow chart of an example process for determining policy premiums, in accordance with one or more embodiments.

FIG. 22 shows a flow chart of another example process for determining policy premiums, in accordance with one or more embodiments.

FIG. 23 shows a flow chart of yet another example process for determining policy premiums, in accordance with one or more embodiments.

FIG. 24 shows an example user interface dashboard configured to facilitate review and/or evaluation of information and/or data metrics received indicative of safety risks of faced by workers, in accordance with one or more embodiments; the view showing a tool of the interface configured to provide status of workers including occupational roles identified by the system as being performed by the workers.

FIG. 25 shows the example user interface dashboard shown in FIG. 24, in accordance with one or more embodiments; the view showing a tool of the interface configured to summarize location based risk of workers over a period of time.

FIG. 26 shows the example user interface dashboard shown in FIG. 25, in accordance with one or more embodiments; the view showing a status summary information window presented when a user hovers over an icon for a day in which location based risk for a worker was rated as acceptable.

FIG. 27 shows the example user interface dashboard shown in FIG. 25, in accordance with one or more embodiments; the view showing a status summary information window presented when a user hovers over an icon for a day in which location based risk for a worker was rated as caution.

FIG. 28 shows the example user interface dashboard shown in FIG. 24, in accordance with one or more embodiments; the view showing a tool of the interface configured to summarize detected instances of sensor data indicative of work performed by workers.

FIG. 29 shows the example user interface dashboard shown in FIG. 24, in accordance with one or more embodiments; the view showing a tool of the interface configured to summarize data related to presence of workers in different designated areas of a workplace.

FIG. 30 shows the example user interface dashboard shown in FIG. 24, in accordance with one or more embodiments; the view showing a tool of the interface configured to summarize data metrics for a selected location; the view showing temperature readings for the selected location.

FIG. 31 shows the example user interface dashboard shown in FIG. 24, in accordance with one or more embodiments; the view showing a tool of the interface configured to summarize data metrics for a selected location; the view showing humidity readings for the selected location.

FIG. 32 shows the example user interface dashboard shown in FIG. 24, in accordance with one or more embodiments; the view showing a tool of the interface configured to summarize data metrics for a selected location; the view showing heat index readings for the selected location.

FIG. 33 shows the example user interface dashboard shown in FIG. 24, in accordance with one or more embodiments; the view showing a tool of the interface configured to summarize data metrics for a selected location; the view showing CO2 readings for the selected location.

FIG. 34 shows the example user interface dashboard shown in FIG. 24, in accordance with one or more embodiments; the view showing a tool of the interface configured to summarize data metrics for a selected location; the view showing TVOC readings for the selected location.

FIG. 35 shows the example user interface dashboard shown in FIG. 24, in accordance with one or more embodiments; the view showing a tool of the interface configured to summarize data metrics for a selected location; the view showing atmospheric pressure readings for the selected location.

FIG. 36 shows the example user interface dashboard shown in FIG. 24, in accordance with one or more embodiments; the view showing a tool of the interface configured to summarize data metrics for a selected location; the view showing sound level readings for the selected location.

FIG. 37 shows the example user interface dashboard shown in FIG. 24, in accordance with one or more embodiments; the view showing a tool of the interface configured to summarize data metrics for a selected location; the view showing recorded light levels for the selected location.

FIG. 38 shows the example user interface dashboard shown in FIG. 24, in accordance with one or more embodiments; the view showing a tool of the interface configured to summarize data metrics for various locations.

FIG. 39 shows the example user interface dashboard shown in FIG. 24, in accordance with one or more embodiments; the view showing a tool of the interface configured to summarize data metrics for various locations; the view showing a travel report for a selected worker; the travel report providing a map that is color coded to represent the amount of time the selected worker spent in different locations.

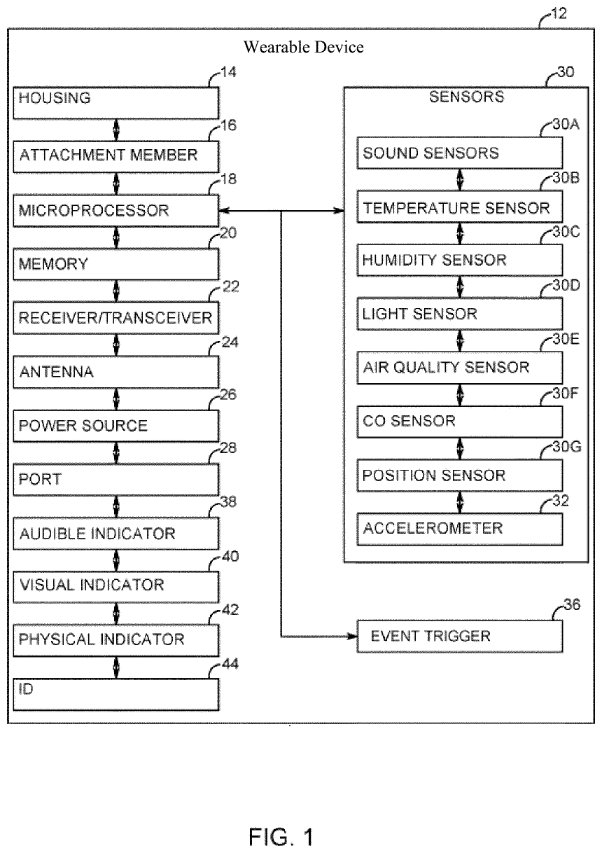

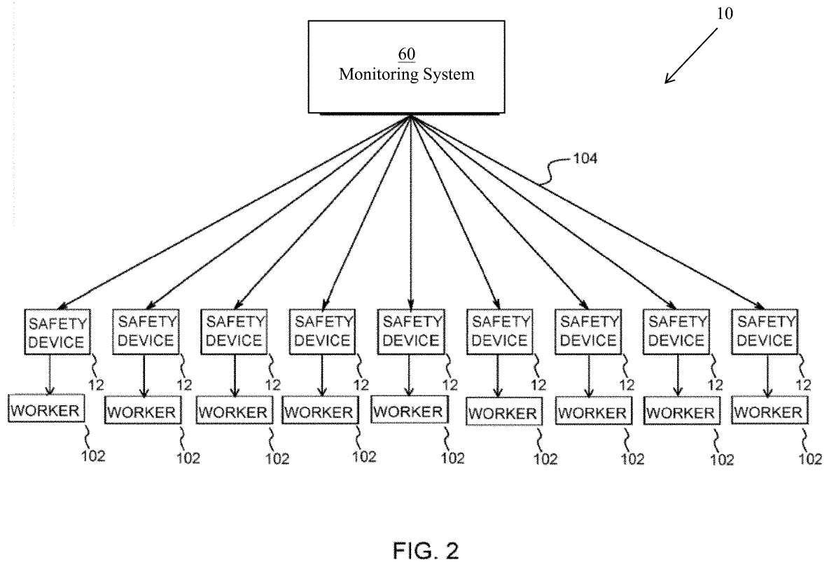

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of gathering information for assessment of safety risk and worker's compensation premiums. However, the embodiments are not so limited. It is appreciated that the embodiments may be adapted for use in other applications which may be improved by the disclosed structures, arrangements and/or methods. The system is merely shown and described as being used in in the context of context of gathering information for assessment of worker risk and worker's compensation premiums for ease of description and as one of countless examples.

### System 10:

With reference to the figures, a system for assessing risk 10 of workers 102 is presented (system 10). In one or more arrangements, system 10 includes a plurality of wearable devices 12, a monitoring system 60 and a policy management system 62, among other components.

### Wearable Devices 12:

Wearable devices 12 are formed of any suitable size, shape and design and are configured to record information indicative of tasks performed by workers and/or information indicative of safety risks encountered by workers during a work shift, such as environmental conditions as well as near misses. In one or more arrangements, recorded information may include, for example, location of workers 102 during a work shift, proximity to high risk machinery, air quality, sound levels, data indicative of physicality of tasks performed by workers such as heart rate, temperature, perspiration level, number of steps, distance traveled, accelerometer data, and/or other data acquired by sensors 30 of wearable devices 12.

In one or more arrangements, as is shown, wearable device 12 includes a core 14. Core 14 is formed of any suitable size, shape and design and is configured to house, hold, and shelter the components of wearable device 12.

In one or more arrangements, wearable device 12 is configured to be worn by a worker 102 and in this way, wearable device 12 is considered to be a wearable device. To facilitate being worn by a worker 102 while working, an attachment member 16 is connected to or formed into wearable device 12 and/or core 14 of wearable device 12. In one or more arrangements, as is shown, attachment member 16 is a band, strap, belt, elastic strap or the like, that is attachable to a worker's arm wrist, waist or other part of the body or clothing worn by the worker 102. In one or more arrangements, it is desirable to attach the wearable device 12 to the worker's non-dominant arm while working. Alternatively, attachment member 16 is formed of any other device that connects two components together such as a snap-fit member, a clip, hook-and-loop arrangement, a button, a snap, a zipper-mechanism, a zip-tie member, or the like, just to name a few. As another arrangement, wearable device 12 can be attached to or formed as part of a piece of clothing or equipment, such as a safety vest, a helmet or the like. In one or more arrangements, as is further described herein, core 14 of wearable device 12 is held within a holster 120 in a removable manner and attachment member 16 is connected to holster 120, as is further described herein.

In one or more arrangements, as is shown, wearable device 12 includes a plurality of electronic components that are configured to act in concert with one another and carry out the purpose and function of wearable device 12, which is to detect record and report information about the workplace conditions surrounding a worker 102 while working. In one or more arrangements, wearable device 12 includes one or more microprocessors 18 and memory 20. Microprocessor 18 is any electronic device which receives inputs, such as signals or information, and processes it in accordance with instructions stored in memory 20. Memory 20 is any device which stores information and allows for retrieval of this information upon command. In one or more arrangements, microprocessor 18 may have its own onboard memory 20 and microprocessor 18 and memory 20 may be a single unitary and combined component. In another arrangement, memory 20 may be one or more standalone units that are electrically connected to microprocessor 18. In yet another arrangement, microprocessor 18 may have its own onboard memory 20 as well as being connected to memory 20 that is a standalone unit, or any combination thereof. As such, it is hereby contemplated that wearable device 12 may include multiple microprocessors 18 (which may or may not have their own onboard memory 20) and/or multiple devices which serve as memory 20.

In one or more arrangements, wearable device 12 includes a pair of microprocessors 18, with one microprocessor 18 primarily devoted to controlling the operation of recording the sound surrounding the worker 102, and the other microprocessor 18 devoted to controlling the other operations of the wearable device 12.

In one or more arrangements, as is shown, wearable device 12 includes an antenna 22 which is operatively connected to a receiver, transmitter, and/or a transceiver (hereinafter referred to as transceiver 24). Antenna 22 is any device which receives and/or transmits wireless signals. A receiver is any device that receives wireless signals from antenna 22, processes these signals and transmits them to microprocessor 18 or other electronic components. In this way, a receiver receives information from antenna 22. A transmitter is any device that receives signals from microprocessor 18, or other electronic components, processes these signals and transmits them through antenna 22 for over the air broadcasting. In this way, a transmitter transmits information through antenna 22. A transceiver is any device which is capable of operating as both a receiver and a transmitter. It is hereby contemplated that wearable device 12 includes a receiver, or a transmitter or both a receiver and transmitter, which may be a single combined electronic device, separate devices, or a plurality of devices. Reference shall be made herein to “transceiver 24” for purposes of simplicity; however, reference to the term “transceiver” shall be understood to include a receiver alone, a transmitter alone, a receiver and a transmitter, a transceiver, or any combination thereof. Transceiver 24 may be configured to communicate using any protocol such as 802.11/Wi-Fi, Wi-Max, Bluetooth, Bluetooth Low Energy, UltraWideband (UWB), ZigBee, Zwave, GSM/EDGE, UMTS/HSPA+/HSDPA, CDMA, LTE, LoRa, FM/VHF/UHF networks and/or any other communication medium and/or protocol. The use of a transceiver that facilitates two-way communication facilities the transmission of over-the-air updates to cores 14 from a central processor or command center which ensures that the software and/or firmware of the core 14 is always up to date.

In the arrangement shown, as one example, wearable device 12 includes a power source 26 which is operatively connected to the electronic components of wearable device 12 such that power source 26 provides power to these electronic components. Power source 26 is formed of any suitable size, shape, and design. In one or more arrangements, power source 26 is formed of one or more replaceable/disposable batteries. In another arrangement, power source 26 is formed of one or more rechargeable batteries.

In one or more arrangements, as is shown, wearable device 12 includes a port 28, which is operatively connected to the electronic components of wearable device 12. Port 28 is formed of any suitable size, shape and design and is configured to allow for the reception and transmission of information as well as charging of on board power source 26.

In one or more arrangements, as is shown, wearable device 12 includes a plurality of sensors 30. Sensors 30 are formed of any suitable size, shape and design and are configured to sense environmental conditions surrounding the worker 102 while working. In one or more arrangements, wearable device 12 includes a plurality of sensors 30.

In one or more arrangements, wearable device 12 includes a sound sensor 30A. Sound sensor 30A is formed of any suitable size, shape and design and is configured to detect the volume level and/or frequency of sound surrounding the worker 102. In one or more arrangements, sound sensor 30A is a microphone that is accessible through one or more openings 114 in core 14 that provide unfettered access for the sound to reach the microphone. Sound sensor 30A allows for the detection of elevated sounds, abrupt spikes in sounds, loud noises, irritating or distracting frequencies or the like. Sound sensor 30A also allows for the detection of when a volume threshold is approached or exceeded.

In one or more arrangements, wearable device 12 includes a temperature sensor 30B. Temperature sensor 30B is formed of any suitable size, shape and design and is configured to detect the temperature of the environment surrounding the worker 102. The same and/or an additional temperature sensor 30B may be configured to detect the temperature of the worker 102 themselves. In one or more arrangements, temperature sensor 30B is a thermometer. Temperature sensor 30B allows for the detection of high or low temperatures as well as abrupt changes in temperature. Temperature sensor 30B also allows for the detection of when a temperature threshold is approached or exceeded. In one or more arrangements, wearable device 12 includes a humidity sensor 30C. Humidity sensor 30C is formed of any suitable size, shape and design and is configured to detect the humidity of the environment surrounding the worker 102. The same and/or an additional humidity sensor 30C may be configured to detect the humidity level, moisture level or perspiration level of the worker 102 themselves. Humidity sensor 30C allows for the detection of high or low levels of humidity as well as abrupt changes in humidity. Humidity sensor 30C also allows for the detection of when a humidity threshold is approached or exceeded. In one or more arrangements, wearable device 12 includes a light sensor 30D. Light sensor 30D is formed of any suitable size, shape and design and is configured to detect the light levels of the environment surrounding the worker 102. Light sensor 30D allows for the detection of high or low levels of light as well as abrupt changes in light levels. Light sensor 30D also allows for the detection of when a light threshold is approached or exceeded. In one or more arrangements, light sensor is operably connected to and/or accessible by a light pipe 116. Light pipe 116 is any device that facilitates the collection and transmission of light from the environment surrounding the worker 102. In one or more arrangements, light pipe 116 is a clear, transparent, or translucent material that extends from the exterior of the core 14 to the light sensor 30D and therefore covers and protects light sensor 30D while enabling the sensing of light conditions.

In one or more arrangements, wearable device 12 includes an air quality sensor 30E. Air quality sensor 30E is formed of any suitable size, shape and design and is configured to detect the air quality of the environment surrounding the worker 102, the particulate matter in the air of the environment surrounding the worker 102, the contaminant levels in the air of the environment surrounding the worker 102, or any particular contaminant level in the air surrounding the worker 102 (such as ammonia, chlorine, or any other chemical, compound or contaminant). Air quality sensor 30E allows for the detection of high contaminant levels in the air as well as abrupt changes in air quality. Air quality sensor 30E also allows for the detection of when an air quality threshold is approached or exceeded.

In one or more arrangements, air quality sensor 30E is a total volatile organic compound sensor, also known as a TVOC sensor. Volatile organic compounds (or VOCs) are organic chemicals that have a high vapor pressure at ordinary room temperature. VOCs are numerous, varied, and ubiquitous. They include both human-made and naturally occurring chemical compounds. Most scents or odors are of VOCs. In this arrangement, air quality sensor 30 is configured to detect VOCs. Also, in one or more arrangements, air quality sensor 30E is accessible through one or more openings 114 in core 14 that provide unfettered access and airflow for sensing by air quality sensor 30E.

In one or more arrangements, wearable device 12 includes a carbon monoxide (CO) sensor 30F. CO sensor 30F is formed of any suitable size, shape and design and is configured to detect CO levels of the environment surrounding the worker 102. CO sensor 30F allows for the detection of high CO levels in the air as well as abrupt changes in CO levels. CO sensor 30F also allows for the detection of when a CO threshold is approached or exceeded. Of course, sensor 30F, or additional sensors 30, may be used to sense other gasses in the air around the worker 102, such as carbon dioxide, ozone, or any other gas or other content of the air around the worker 102. Also, in one or more arrangements, sensor 30F is accessible through one or more openings 114 in core 14 that provide unfettered access and airflow for sensing by sensor 30F.

In one or more arrangements, wearable device 12 includes a position sensor 30G. Position sensor 30G is formed of any suitable size, shape and design and is configured to detect the position of the worker 102 within the manufacturing facility. Notably, the term manufacturing facility is to be construed in a broad manner and may include being within one or a plurality of buildings. However, the manufacturing facility may include being outside and unconstrained by the boundaries of a building or any particular grounds. Position sensor 30G allows for the detection of movement of the worker 102 within the manufacturing facility, the speed of movement of the worker 102 within the manufacturing facility, the tracking of the position of the worker 102 within the manufacturing facility, among any other speed, location, direction, inertia, acceleration or position information. This position information can be aggregated over the course of the worker's shift to determine the amount of distance traveled by the worker 102, the average speed, the mean speed, the highest speed, or any other information. In addition, this position information can be aggregated to determine the areas where the worker 102 concentrated their time. In addition, this position information can be correlated with the information detected by the other sensors to determine the concentration of certain environmental factors in different areas of the manufacturing facility. Position sensor 30 may be a GPS device, a wireless device (e.g., Wi-Fi and/or RFID) configured to detect presence of nearby wearable devices, a wireless device that utilizes trilateration from known points, or any other device that detects the position of wearable device 12 and the worker 102.

In one or more arrangements, wearable device 12 includes an accelerometer 32. Accelerometer 32 is formed of any suitable size, shape and design and is configured to detect acceleration and/or movement of the wearable device 12, such as when a worker 102 trips on something on the floor and almost falls, or when a worker 102 falls off of a ladder, is hit by a fork truck, or has another traumatic event. Accelerometer 32 may be formed of any acceleration detecting device such as a one axis accelerometer, a two-axis accelerometer, a three axis accelerometer or the like. Accelerometer 32 also allows for the detection changes in acceleration, detection of changes in direction as well as elevated levels of acceleration.

In an alternative arrangement, or in addition to an accelerometer 32, a gyroscope or gyro-sensor may be used to provide acceleration and/or movement information. Any form of a gyro is hereby contemplated for use, however, in one or more arrangements a three-axis MEMS-based gyroscope, such as that used in many portable electronic devices such as tablets, smartphones, and smartwatches are contemplated for use. These devices provide 3-axis acceleration sensing ability for X, Y, and Z movement, and gyroscopes for measuring the extent and rate of rotation in space (roll, pitch, and yaw).

In another arrangement, and/or in addition to an accelerometer 32, a magnetometer may be used to provide acceleration and/or movement information. Any form of a magnetometer that senses information based on magnetic fields is hereby contemplated for use. In one or more arrangements, a magnetometer is used to provide absolute angular measurements relative to the Earth's magnetic field. In one or more arrangements, an accelerometer, gyro and/or magnetometer are incorporated into a single component or a group of components that work in corresponding relation to one another to provide up to nine axes of sensing in a single integrated circuit providing inexpensive and widely available motion sensing.

Wearable device 12 may also include any other sensors 30. For example, in one or more arrangements, wearable device 12 includes one or more sensor 30 that tracks biometric data of the worker 102 including but not limited to, for example, heart rate, blood pressure, blood oxygen levels, blood alcohol levels, blood glucose sensor, respiratory rate, galvanic skin response, bioelectrical impedance, brain waves, and/or combinations thereof.

During operation, sensors 30 detect environmental conditions, such as sound, temperature, humidity, light, air quality, CO levels, TVOC levels, particulate levels, position and acceleration information, direction information, speed information and the like respectively. This information is periodically and/or continuously transmitted to microprocessor 18 and/or stored in memory 20. This information is also periodically and/or continuously transmitted through transceiver 24 and antenna 22 and is communicated to and stored in a database 68, where it is aggregated and analyzed to detect patterns as is described further herein.

Wearable device 12 includes an event trigger 36. Event trigger 36 is formed of any suitable size, shape and design and is configured to allow a worker 102 to indicate that a notable event just occurred, such as an accident that almost occurred (also known as a near miss), such as when the worker 102 trips and almost falls, when the worker 102 is almost struck by a forklift, when products almost fall on the worker 102, when the worker 102 is almost injured by a tool, or the like near misses.

Also, workers 102 are encouraged to use event trigger 36 when a notable event occurs. This may be any information that the worker 102 believes would be helpful for the safety manager 112 to know about or others in the management of the manufacturing facility. This may include a suggestion as to how to improve the manufacturing facility, problems associated with the layout of the manufacturing facility, the worker 102 noticing that equipment is wearing and likely to fail in the near future, that ear plugs, safety glasses or other protective equipment is failing, that a door fails to lock, that another worker 102 is behaving strangely or taking unnecessary risks, or practically any other information. It has been tested that providing the worker 102 with the instantaneous ability to record suggestions or information at the moment the information dawns on the worker 102, reduces the barriers to providing this information and as such, this information is more-readily provided as it is very easy to provide. In addition, because the information is provided contemporaneous with the worker 102 experiencing the notable event, it has been found that the information is provided in a thorough, unbiased, honest, and straight forward manner. Or said, another way, when a worker 102 waits to report improvements or issues at the end of the shift, the worker 102 is likely to be uninclined to go through the reporting process, they are likely to forget salient details, or their memory of events could fade. In contrast, by providing an easy and contemporaneous recordation of the notable event at or just after the time the event occurs, the information provided tends to be pure and uncorrupted. Due to the ease of simply pressing the event trigger 36 the worker 102 is likely to report the information. More accurate reporting and more frequent reporting allows a safety manager 112 or management in general to be more aware of the issues in the manufacturing facility and able to continuously improve the manufacturing facility. In addition, the timeliness of this information cannot be matched as it is transmitted to the safety manager 112 and/or database 68 as soon as it is recorded and as soon as the wearable device 12 establishes connectivity with database 68 and/or charging base 118 or another wireless communication intermediary, such as a repeater.

In one or more arrangements, event trigger 36 is a button, switch or other device placed on or formed in wearable device 12 that allows the worker 102 to indicate that a notable event (such as a near miss) just occurred. At the time the event trigger 36 is activated, the wearable device 12 records and/or transmits and/or saves a higher level or high-density of environmental information such as sound, temperature, humidity, light, air quality, CO levels, position and acceleration and the like and transmits this information to database 68. This high-density environmental information is stored along with an audible message provided by the worker 102 explaining why they engaged the event trigger 36. In one or more arrangements, the wearable device 12 continually tracks and stores a predetermined amount of high-density data, such as sixty-seconds two minutes, thirty seconds or the like. This high-density data is tracked and stored in a rolling manner. That is, the high-density data is overwritten or converted to low-density data unless an event occurs that causes the wearable device 12 to save and transmit the high-density data.

As one example, when event trigger 36 is activated, the wearable device 12 stores this high-density information for transmission through port 28 when wearable device 12 is connected to charging base 118, or the wearable device 12 transmits this information wirelessly over the air through antenna 22 when wireless connectivity is established with charging base 118 and/or database 68. When event trigger 36 is not activated, wearable device 12 stores and/or transmits a lower level or low-density of information, or overwrites a portion of the high-density information. That is, by way of example, high-density information may include storing and/or transmitting a sample from sensors 30 once every hundredth of a second or tenth of a second, whereas low-density information may include storing and transmitting a sample from sensors once every second or once every two seconds, or the like. In this way, a balance can be had between recording a high sensitivity of information at and just prior to the time an accident, near miss or notable event occurs, while recording enough information to develop patterns and predict potential accidents while not being overly encumbered by too much data when an accident, near miss or notable event situation has not occurred.

In one or more arrangements, when event trigger 36 is activated, the sound sensor 30A, or microphone, is activated for a predetermined time or period thereafter. This allows the worker 102 to voice record the events of the accident, near miss or notable event contemporaneously, or just after, the event occurs. This allows for an honest and relatively unbiased account of the event shortly after the near miss occurs. This voice recording can be converted into text and automatically inserted into an event report, or alternatively the voice recording itself may be inserted directly into an event report. In one or more arrangements, the audio recording through sound sensor 30A occurs for a predetermined amount of time such as for thirty seconds or a minute after the event trigger 36 is pressed. In another arrangement, the audio recording through sound sensor 30A occurs for so long as the wearable device 12 detects that the worker 102 is talking. In another arrangement, the audio recording through sound sensor 30A occurs for so long as the worker 102 depresses or engages the event trigger 36. In another arrangement, sound sensor 30 records the audio for a length of time or period determined by any other manner, method or means.

In one or more arrangements, to eliminate or reduce unintentional engagement of the event recording function of wearable device 12, wearable device 12 is configured to require a special engagement or unlock procedure to start the event recording function. In one or more arrangements, a double engagement or double press of event trigger 36 is required to engage the event recording function. In another arrangement, an elongated press of event trigger 36 is required to engage the event recording function.

In yet another arrangement, an accident or near miss or other safety matter can be distinguished from a notable event (such as a suggestion for improvement of a process or the factory layout by a worker 102) by the manner in which the event trigger 36 engaged. As one example, a safety issue is reported by pressing the event trigger 36 twice and a notable event that is not related to immediate safety concerns is reported by pressing the event trigger 36 three times. Alternatively, two different triggers 36, such as two buttons, can be provided: one dedicated for safety issues the other dedicated for non-safety issues. Or any other manner of reporting safety issues and non-safety issues may be used. By separating the reporting of safety issues from non-safety issues, this allows reports of safety issues, accidents and near misses to be expedited through the system 10, such as immediately emailing or texting them to a safety manager 112 or other manager so that they can respond quickly to safety issues while allowing non-safety issues to be handled as a lower priority. In one or more arrangements, the report of safety issues is instantaneously reported over the air to charging base 118 and/or database 68 and is thereafter contemporaneously, immediately, and/or quickly sent to a safety manager's phone, email, text message or the like for their immediate attention. In contrast, non-safety related matters are stored on wearable device 12 and downloaded once core 14 is installed in charging base 118. In this way, the system 10 includes an expedited path for the report of notable events that are safety issues and the system 10 includes a non-expedited path for the report of notable events that are not safety issues.

In one or more arrangements, wearable device 12 includes one or more audible indicators 38. Audible indicator 38 is formed of any suitable size, shape and design and is configured to provide an audible indication to the worker 102 when a hazard condition may be present or when a safety threshold is approached or exceeded or when any other event or issue occurs that the worker 102 should be informed of. In one or more arrangements, audible indicator 38 is a speaker, or any other device that is configured to produce or repeat a sound, such as a tone, an alarm, audible instructions, or any other sound.

As an example, when the decibel level in the environment surrounding the worker 102 reaches 90% of the safety threshold sound, as is sensed by sound sensor 30A, the microprocessor 18 detects that a safety threshold is approached and issues an alarm or a prerecorded spoken voice instruction or any other audible indication through audible indicator 38, which informs the worker 102 to retreat from the potentially unsafe condition. Audible indicator 38 may also be used to provide any instructions to the worker 102, such as telling them through a voice command to join a mandatory meeting in the lobby, informing them of a fire alarm or contaminant alarm, providing them with their schedule for the day, providing them with the goals for the day, providing them with instructions for the day, or providing information on any other condition or instruction.

In one or more arrangements, wearable device 12 includes one or more visual indicators 40. Visual indicator 40 is formed of any suitable size, shape and design and is configured to provide a visual indication to the worker 102 when a hazard condition may be present or when a safety threshold is approached or exceeded or when any other event or issue occurs that the worker 102 should be informed of. In one or more arrangements, visual indicator 40 is one or more lights, LEDs or any other illuminating device placed in core 14 which illuminates. In one or more arrangements, visual indicator 40 is formed of a red, a green and a blue LED which illuminate in various ways to provide various information. However, any other number of lights or LEDs are hereby contemplated for use as is any other color of lights or LEDs.

As an example, when the air quality in the environment surrounding the worker 102 reaches a first safety threshold as is detected by the microprocessor 18 though air quality sensor 30E (e.g. exceeds 80% of a safety threshold) a first light of the visual indicator 40 is illuminated, such as the blue LED; when the air quality in the environment surrounding the worker 102 reaches a second safety threshold as is detected by the microprocessor 18 though air quality sensor 30E (e.g. exceeds 90% of a safety threshold) a second light of the visual indicator 40 is illuminated, such as the green LED, or both the green and the blue LED are illuminated; when the air quality in the environment surrounding the worker 102 reaches a third safety threshold as is detected by the microprocessor 18 though air quality sensor 30E (e.g., reaches or exceeds 100% of a safety threshold) a third light of the visual indicator 40 is illuminated, such as the red LED, or the green, blue and red LEDs are illuminated. Illumination of visual indicators 40 informs the worker 102 to retreat from the potentially unsafe condition or location.

In another arrangement, various visual indicators 40 may be used to provide information regarding the state of operation of wearable device 12. As an example, one light of the visual indicators 40 of the wearable device 12 may be illuminated when the wearable device 12 is powered and operational, such as illumination of a blue LED. As another example, one light of the visual indicators 40 of the wearable device 12 may be illuminated when the power source 26 of wearable device 12 reaches a power or charge threshold as is sensed by microprocessor 18, such as falling below a 10% charge level and as such illumination of this visual indicator 40 informs the worker 102 it is time to charge the wearable device 12. As another example, one light of the visual indicators 40 of the wearable device 12 may be illuminated when the wearable device 12 is wirelessly connected to the internet, a hub, or other communication device.

In one or more arrangements, wearable device 12 includes one or more physical indicators 42. Physical indicator 40 is formed of any suitable size, shape and design and is configured to provide a physical indication to the worker 102 when a hazard condition may be present or when a safety threshold is approached or exceeded or when any other event or issue occurs that the worker 102 should be informed of. In one or more arrangements, physical indicator 42 is a vibration device placed in core 14 which vibrates upon command. As an example, when the air quality in the environment surrounding the worker 102 reaches a first safety threshold as is detected by the microprocessor 18 though air quality sensor 30E (e.g. exceeds 90% of a safety threshold) physical indicator 42 activates. Upon sensing this vibration or physical indication from physical indicator 42, the worker 102 retreats from the potentially unsafe condition.

Any other form of indicator is hereby contemplated for use with wearable device 12 and is used to provide information to the worker 102. As an example, in one or more arrangements, core 14 may connect to a worker's headphones or other listening device (such as an earbud) through port 28, or wirelessly through wireless pairing, and when information becomes available, such as an announcement or reaching or exceeding a safety threshold, the wearable device 12 transmits an audible signal to the worker's headphones or listening device. In this way, by connecting, either through a wired connection or wirelessly to the worker's headphones or other listening device the wearable device 12 provides audible information directly to the worker 102 thereby eliminating or reducing the possibility that the worker 102 does not hear the information due to the noisy environment.

Wearable device 12 includes an ID 44. ID 44 is any form of a unique identifier that identifies any one particular wearable device 12 from other wearable devices 12 used within a manufacturing facility. In one or more arrangements, ID 44 is a code that can be scanned, such as a bar code, QR code or other code. In another arrangement, ID 44 is a unique identifier that is contained within a near field communication (NFC) chip or other communication device. In another arrangement, ID 44 is a serial number. Any other form of identification is hereby contemplated for use as ID 44.

While some arrangements may be primarily described with reference to wearable devices 12 that are configured to be attached to a worker's arm during a work shift, the embodiments are not so limited. Rather, it is contemplated that in some various arrangements, wearable device 12 may be alternatively or additionally configured to be attached to and/or carried by a worker 102 using various means or methods including but not limited to, for example: armbands, headbands, wrist straps, rings, belts, bandoleers, harnesses, clips, hooks, straps, pins, magnets, belt loops, stickers and/or adhesives, footwear attachments, lanyards, wallets, pockets, holsters, keychains, body implantation, and/or any other means and/or method for transporting objects with a worker 102 during a work shift.

Wearable Devices in Operation:

As one example, system 10 is used in a manufacturing facility 100 having a plurality of workers 102 and an electronic network 104. System 10 includes a user interface 106 connected to the electronic network 104 and database 68, which is operated and controlled by management software 108. A plurality of wearable devices 12, one for each worker 102 are used to record information to facilitate assessment of safety risks faced by workers 102 during a work shift.

At the beginning of a shift, workers 102 are assigned a wearable device 12. The unique ID 44 of the wearable device 12 is associated with the particular worker 102 by entering the ID 44 into database 68 by any means such as scanning, NFC, typing, biometric scanning, random allocation, or the like. In this assignment, the particular worker 102 is assigned to the particular core 14 and specific rules or guidelines are associated with the core 14 for use with that particular worker 102. As an example, safety thresholds for a worker 102 that works with loud pressing machines and wears external earmuffs may be much higher than a worker 102 that works in shipping and receiving and does not use any hearing protection. In this way, by assigning particular rules for each worker 102 based on that worker's job and tasks, allows the system 10 to provide more accurate information and determine more accurately when safety issues arise for that particular worker 102 because what may be acceptable for one worker's role may not be acceptable for another worker's role.

Once the core 14 is assigned to the worker 102, the worker 102 attaches wearable device 12 to themselves, such as placing an elastic strap of attachment member 16 around the worker's non-dominant arm and tightening it by a buckle, Velcro, buttons or any other manner or method. Alternatively, wearable device 12 is attached to their helmet, belt, pocket, collar, shirt, or to any other portion of their body or clothing or equipment by any manner or means.

Once attached, the wearable device 12 is activated. Upon activation, wearable device 12 establishes a wireless connection to database 68 through electronic network 104 and begins sending and receiving pertinent information. Also once activated, wearable device 12 begins sensing environmental conditions surrounding the worker 102 through sensors 30.

As an example, where wearable device 12 includes a sound sensor 30A, a temperature sensor 30B, a humidity sensor 30C, a light sensor 30D, an air quality sensor 30E, a CO sensor 30F, a position sensor 30G and an accelerometer 32, the wearable device 12 periodically senses sound, temperature, humidity, light, air quality, CO levels, position and acceleration.

These environmental conditions are sensed and at least temporarily recorded or buffered in high-density (such as one sample every tenth of a second or every hundredth of a second, or the like, or in the example of sound, the sound in the environment is continuously recorded for a predetermined amount of time or period) to onboard memory 20 and/or transmitted through transceiver 24 and antenna 22 through electronic network 104 to database 68.

If an accident or a near miss occurs or a notable event occurs, this high-density of information is retained and stored on database 68 for later analysis. Buffering or retaining a high-density of information allows for an in-depth analysis of the conditions around the time of an accident or near miss. This high-density of information is retained around the time of an accident or near miss as it may shed additional light on the events surrounding the accident or near miss that may not be discernable if only low-density information is retained.

If on the other hand, an accident or near miss is not recorded, this high-density of information is overwritten, or not retained, and instead a low-density of information (such as one sample every half second or every second) is recorded, stored, and/or transmitted. Recording and/or transmitting a low-density of information continuously throughout the worker's shift allows for analysis and recordation of environmental information at an appropriate level of detail, while not being overly cumbersome and cumulative and overburdening the system 10 with too much unnecessary information at too high a level of detail.

In one or more arrangements, wearable device 12 periodically transmits environmental information to database 68 through a wireless connection over electronic network 104 (such as when wearable device 12 acquires a Wi-Fi connection). In an alternative arrangement, wearable device 12 stores environmental information sensed by sensors 30 on onboard memory 20 throughout the worker's shift. Then, at the end of the shift, when wearable device 12 is physically plugged into electronic network 104 by port 28 the information stored on memory 20 is downloaded to database 68. Also, while plugged in by port 28, the power source 26 is recharged.

In one or more arrangements, to ensure the purity of data collected, core 14 includes a proximity sensor or cover-sensor as one of the sensors 30. Proximity sensor is configured to determine when the core 14 is covered, such as when a worker 102 puts a welding jacket on over the core 14, and when it is covered the core 14 takes corrective action, such as shutting down particular sensors, going into a sleep mode and/or filtering out what environmental data (such as light levels, sound levels or air quality as these would be affected by being covered) should not be recorded or reported due to be being covered.

Tripping Example:

As an example, during the worker's shift, wearable device 12 continuously senses the environmental conditions around the worker 102 using sensors 30, including the position of the worker 102 within the manufacturing facility, as well as recording the sound around the worker 102. The wearable device 12 temporarily stores this information in high-density on the memory 20 of the wearable device 12. Unless a notable event, near miss or accident occurs, this high-density of information is overwritten and only a low-density of information is retained on memory 20. This recordation of high-density information and then overwriting the information while only retaining a low-density of information is repeated until, during the worker's shift the worker 102 trips on a pallet that was improperly placed in a high traffic area. Upon tripping on this pallet, the accelerometer 32 senses the unusual acceleration and microprocessor 18 identifies this spike in acceleration as a potential accident or near miss (e.g. the system 10 is configured to apply machine learning and artificial intelligence to determine what are known as “signatures” that indicate a near miss or accident occurred, over time and with the application of more examples and more data, the system 10 becomes smarter and better able to distinguish when an accident or near miss occurs and separates these events from non-events). Microprocessor 18 interprets the information supplied to it through sensors 30 by the instructions stored in memory 20 and is programmed to identify the large spike in acceleration or “tripping signature” as a potential accident or near miss. Upon identifying this tripping incident as a possible accident or near miss, the microprocessor 18 retains the high-density of information for a predetermined amount of time both before and after the accident or near miss (such as 60 seconds before and 60 seconds after or the like).

In one or more arrangements, in response to sensing this accident or near miss, microprocessor 18 prompts worker 102 to provide a recitation or description of the accident or near miss through an audible indication using audible indicator 38, visual indication using visual indicator 40, a physical indication using physical indicator 42 or any combination of these indicators 38, 40, 42. In one or more arrangements, the audible indication is an audible tone, such as a beep or series of beeps, or audible instructions such as “A potential accident was detected, please describe what happened.” In response, the worker 102 is trained to describe what occurred, which gives the worker 102 an opportunity to contemporaneously describe the events. This eliminates the potential that the worker 102 forgets what happened or confuses what happened in this event with another event.

In an alternative arrangement, the worker 102 is trained to press or engage the event trigger 36 when they experience a near miss or accident. Once the worker 102 presses or engage the event trigger 36 the worker 102 is also trained to speak into the wearable device 12 and describe the events that just occurred, or alternatively once the event trigger 36 is pressed or engaged the wearable device 12 prompts the worker 102 to provide a description of the events that just occurred.

In one or more arrangements, upon sensing this accident or near miss, wearable device 12 transmits a signal through a wireless connection to electronic network 104 that an accident or near miss just occurred. This signal indicates who the worker 102 is that experienced the accident or near miss through association of the unique ID 44 of wearable device 12 to that worker 102, the position of the accident or near miss as is detected by position sensor 30G, as well as the nature of the accident or near miss, which in this example is a potential trip or fall, as is sensed by accelerometer 32. Any other sensed information may also be provided wearable device 12. In one or more arrangements, the audible recording of the worker's description of the accident or near miss is also transmitted, or this audible recitation is automatically converted to text, which is transmitted in text form as part of this signal.

As this event is considered an accident or near miss, it receives expedited attention. Wearable device 12 transmits some or all of the information related to the incident over the air to monitoring system 60 via charging base 118, electronic network 104 or any other communication path or communication device or system that is used in association with the system 10.

Management Software 108:

In one or more arrangements, information provided by wearable devices 12 is processed by management software 108. Management software 108 converts the information into an incident report and a signal, such as a text message, email, or the like is transmitted to an electronic device 110 (such as a cell phone, a handheld device, their own wearable device 12, an email account, or any other electronic device capable of receiving an electronic message or information) of one or more safety managers 112 or other managers or other persons in charge of managing safety in the manufacturing facility 100. This signal includes the position/location of the event, time of the event, name of the worker 102 involved and type of potential accident or near miss along with any other pertinent information. In one or more arrangements, the audible recording of the worker's description of the accident or near miss is also transmitted, or this audible recitation is automatically converted to text which is transmitted in text form as part of this signal. With this timely information, the safety manager 112 can quickly and effectively respond to the potential accident or near miss. This information is also stored as an incident report in database 68 for risk assessment, policy premium calculation, data mining, data retrieval, data analytics, and/or machine learning and artificial intelligence purposes.

As this event is a safety event, transmission is expedited through the system 10 so that the safety manager 112, a response team or others can quickly respond in attempt to mitigate the injury or damage. In one or more arrangements, when this signal indicating a safety event occurred is received, the location of the event is transmitted to a building control or safety system that then implements alarms, flashing lights or other safety precautions in the affected portion of the manufacturing facility to alert others as to the event and in an attempt to prevent further injury or damage.

Once the safety manager 112 arrives at the scene of the accident or near miss they will see that a pallet was placed in a high traffic area. In response, the safety manager 112 can move the pallet or cordon off the area to prevent future accidents and/or take further corrective actions.

Falling Items Example:

As an example, during the worker's shift, wearable device 12 continuously senses the environmental conditions around the worker 102 using sensors 30, including the position of the worker 102 within the manufacturing facility, as well as recording the sound around the worker 102. The wearable device 12 temporarily stores this information in high-density on the memory 20 of the wearable device 12. Unless a notable event, near miss or accident occurs, this high-density of information is overwritten and only a low-density of information is retained on memory 20. This recordation of high-density information and then overwriting the information while only retaining a low-density of information is repeated until, during the worker's shift the worker 102 experiences falling items. As an example, during the worker's shift, the worker 102 climbs up on a ladder to remove some items from a shelf. Upon doing so, a number of items fall and almost strike the worker 102 in the head because they were improperly stacked or stored.

In response to this near miss, the worker 102 presses the event trigger 36. In response to the event trigger 36 being activated, microprocessor 18 retains the high-density of information for a predetermined amount of time both before and after the accident or near miss (such as 60 seconds before and 60 seconds after, or the like).

In one or more arrangements, in response to the event trigger 36 being activated, microprocessor 18 prompts worker 102 to provide a recitation or description of the accident or near miss through an audible indication using audible indicator 38 or a visual indication using visual indicator 40 or a physical indicator using physical indicator 42. In one or more arrangements, the audible indication is an audible tone, such as a beep or series of beeps, or audible instructions such as “A potential accident was detected, please describe what happened.” In response, the worker 102 is trained to describe what occurred, which gives the worker 102 an opportunity to contemporaneously describe the events. This eliminates the potential that the worker 102 forgets what happened or confuses what happened in this event with another event.

In one or more arrangements, when the event trigger 36 is activated, indicating that an accident or near miss occurred, wearable device 12 transmits a signal through a wireless connection to electronic network 104 that an accident or near miss occurred. This signal indicates who the worker 102 is that experienced the accident or near miss through association of the unique ID 44 of wearable device 12, and the position and time of the accident or near miss as is detected by position sensor 30G, as well as the nature of the accident or near miss, which in this example is an activation of the event trigger 36. In one or more arrangements, the audible recording of the worker's description of the accident or near miss is also transmitted, or this audible recitation is automatically converted to text which is transmitted in text form as part of this signal.

In one or more arrangements, management software 108 converts the information provided by wearable device 12 into an incident report and a signal, such as a text message, email, or the like is transmitted to an electronic device 110 (such as a cell phone, a handheld device, their own wearable device 12, an email account, or any other electronic device capable of receiving an electronic message or information) of one or more safety managers 112 or other managers or other persons in charge of managing safety in the manufacturing facility 100. This signal includes the position/location of the event, time of the event, name of the worker 102 involved and type of potential accident or near miss along with any other pertinent information. In one or more arrangements, the audible recording of the worker's description of the accident or near miss is also transmitted, or this audible recitation is automatically converted to text which is transmitted in text form as part of this signal. With this timely information, the safety manager 112 can quickly and effectively respond to the potential accident or near miss. This information is also stored as an incident report in database 68 for risk assessment, policy premium calculation, data mining, data retrieval, data analytics, and/or machine learning and artificial intelligence purposes.

As this event is a safety event, transmission is expedited through the system 10 so that the safety manager 112, a response team or others can quickly respond in attempt to mitigate the injury or damage. In one or more arrangements, when this signal indicating a safety event occurred is received, the location of the event is transmitted to a building control or safety system that then implements alarms, flashing lights or other safety precautions in the affected portion of the manufacturing facility to alert others as to the event and in an attempt to prevent further injury or damage.

Once the safety manager 112 arrives at the scene of the accident or near miss they will see that items were stored in the shelving in an unsafe and unstable manner. In response, the safety manager 112 removes the items or cordon off the area to prevent future accidents and/or the safety manager 112 takes further precautionary measures.

Threshold Example:

In one or more arrangements, microprocessor 18 is programmed to indicate whether particular thresholds are exceeded. As an example, when 90% of a volume threshold is exceeded, as is interpreted by microprocessor 18, a signal is transmitted to safety manager 112 informing the safety manager 112 of the potentially dangerous condition. Once received, the safety manager 112 can respond in an attempt to address the problem and reduce the volume in the affected area.

Similarly, when 90% of a volume threshold is exceeded, as is interpreted by microprocessor 18, a signal is transmitted to the worker 102 through audible indicator 38, visual indicator 40 and/or physical indicator 42 indicating to the worker 102 of a potential dangerous condition. This information may be used by the worker 102 to correct the problem or exit the potentially dangerous area.

Notable Event Example:

As one example, a worker 102 during their shift realizes that they have a suggestion to improve a manufacturing step, to improve a workstation or improve the flow of the manufacturing facility, or any other suggestion or improvement. Without system 10, the worker 102 would have to walk to the location of either a safety manager 112, facility manager or other manager(s) office and meet with that person to describe their suggestion. This requires the worker 102 to remove themselves from their work, which reduces productivity and could be considered a punishable event. Alternatively, the worker 102 must take time to fill out a suggestion form or log into a computer and send an email to a safety manager 112 or facility manager. Due to the time and inconvenience involved with doing so, workers 102 rarely follow through with reporting their suggestions.

However, in the system 10 presented, when the worker 102 has an idea or suggestion, the worker 102 presses the event trigger 36. In one or more arrangements, to distinguish this notable event from a safety issue (such as an accident or near miss) the worker 102 presses a separate notable event button or they press the event trigger 36 twice or three times or whatever the configuration is to discern that this engagement of the event trigger 36 is for reporting a notable event or suggestion and not for reporting an immediate safety concern. In doing so, the wearable device 12 assigns the event a lower priority, that is not expedited, in the same manner as a safety event.

In one or more arrangements, in response to the event trigger 36 being activated, in the manner to identify that the worker 102 desires to record or submit a suggestion or identify a notable event, microprocessor 18 prompts worker 102 to provide a recitation or description of the notable event or suggestion through an audible indication using audible indicator 38 or a visual indication using visual indicator 40 or a physical indicator using physical indicator 42. In one or more arrangements, the audible indication is an audible tone, such as a beep or series of beeps, or audible instructions such as “A notable event was detected, please describe what happened.” In response, the worker 102 is trained to describe what occurred or what their suggestions are, which gives the worker 102 an opportunity to contemporaneously describe the events or suggestions at or near the time they occurred. This eliminates the potential that the worker 102 forgets what happened or confuses what happened in this event with another event. This also essentially eliminates the barriers to providing their suggestions for improvement as the worker 102 does not have to leave their work station, they don't have to fill out any paperwork or type out anything (which may be a substantial barrier for many workers 102). In contrast, the worker 102 can simply speak their suggestions while continuing to work. The wearable device 12 also stores the information related to the time and place of the notable event, such as location, time, and what the sensors 30 sensed for inclusion in a notable event report.

In one or more arrangements, when the event trigger 36 is activated in a manner indicating that a notable event has been encountered, the wearable device 12 assigns this event a lower priority than a safety issue such as a near miss or an accident. Wearable device 12 develops a notable event report which includes the spoken words of the worker 102, which may be retained as spoken words and/or may be converted to text, as well as the time, location and any other pertinent information that is sensed by the sensors 30 of wearable device 12.

In one or more arrangements, this information is stored on memory 20 of wearable device 12 until the wearable device 12 is connected to charging base 118 at which point the information is transmitted over electronic network 104 to database 34 and other components of the system 10 where the information is contained within a notable event report, which is provided to safety manager or facilities manager or other manager or team for their consideration and attention.

In alternative arrangement, this information is stored on memory 20 until it is convenient for wearable device 12 to transmit this information over the air to the other components of system 10, such as database 34, charging base 118, and/or management software 108. Again, because the information is deemed not to be an immediate safety concern this information is deemed to be of a lower priority level and is not expedited. Meaning that the wearable device 12 may be allowed to transmit the information at a time convenient for the wearable device 12, such as when the wearable device 12 establishes a strong signal with electronic network 104.

In another arrangement, the information related to the notable event may be treated in the same manner as the safety event information described above. However, by providing notable event information in the same and undiscernible manner as safety information, this has the potential of distracting the safety manager 112 from responding quickly to true safety concerns and issues.

In one or more arrangements, the system 10 combines all the notable event reports into a single report that is provided to the safety manager 112, facility manager or other manager or team on a daily, weekly, monthly or quarterly basis, or on any other basis that is convenient and facilitates allocation of proper resources to these notable events.

Example of Core, Holster and Attachment Member:

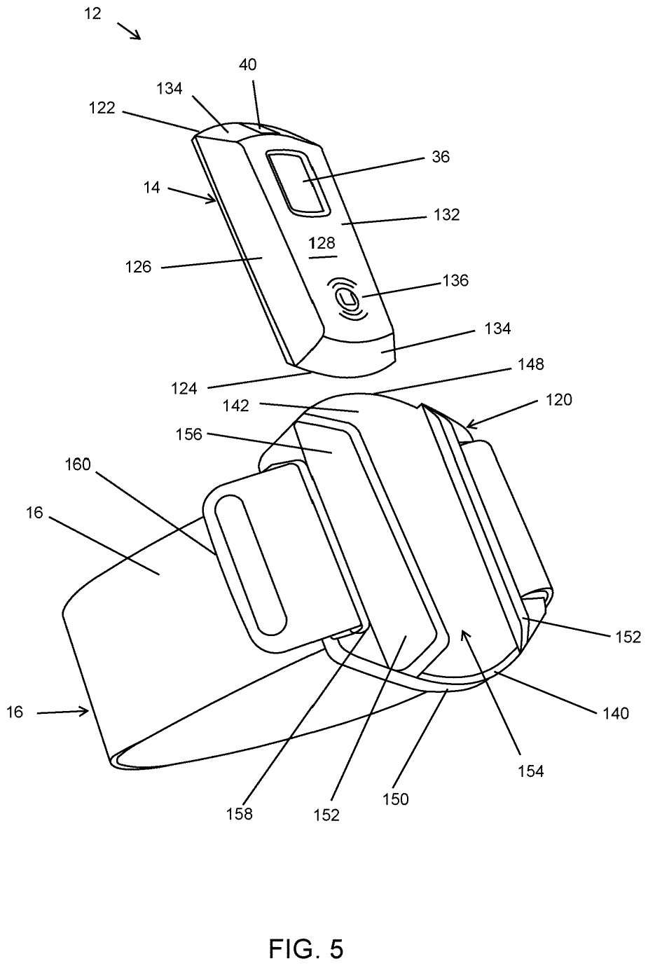

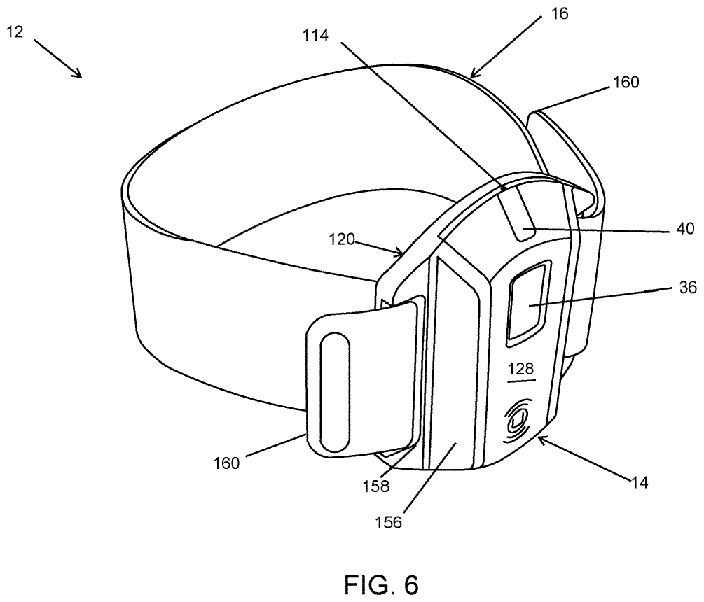

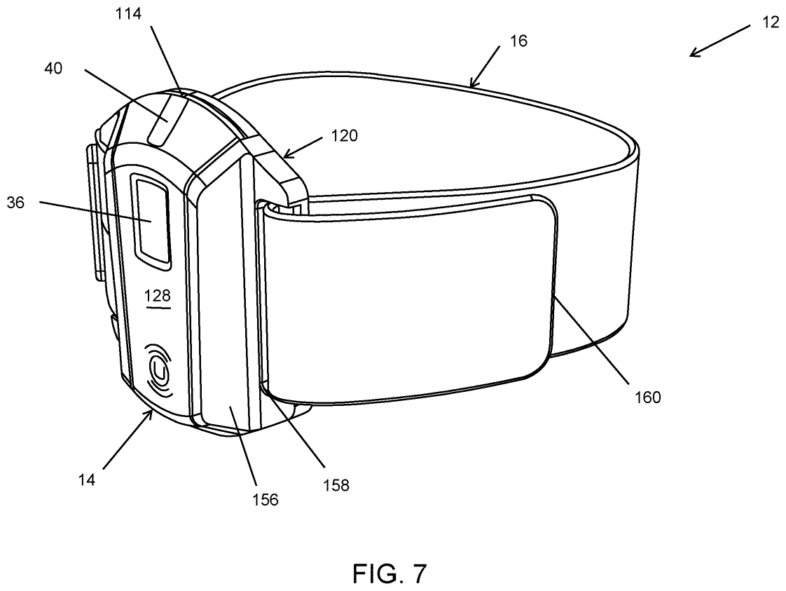

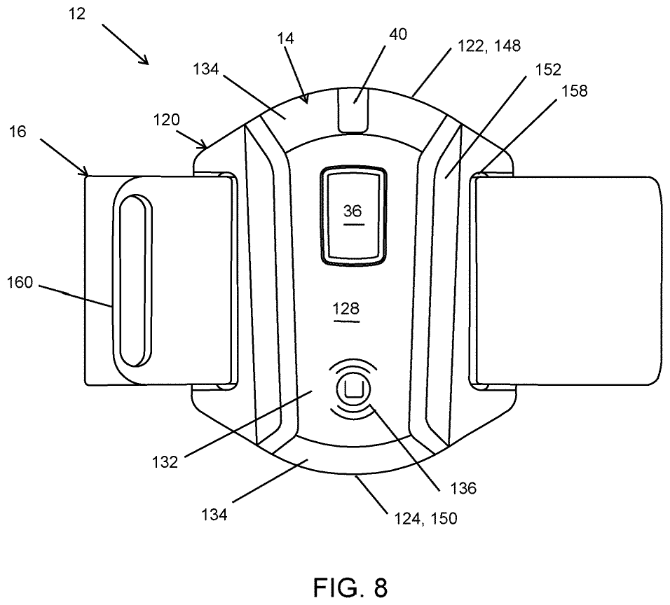

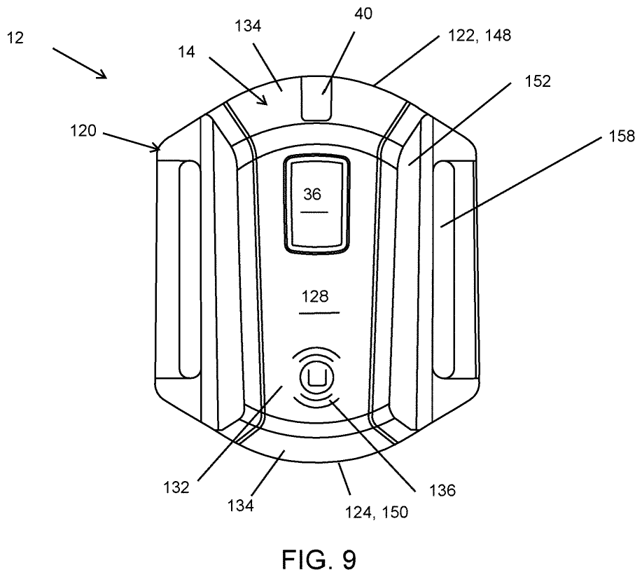

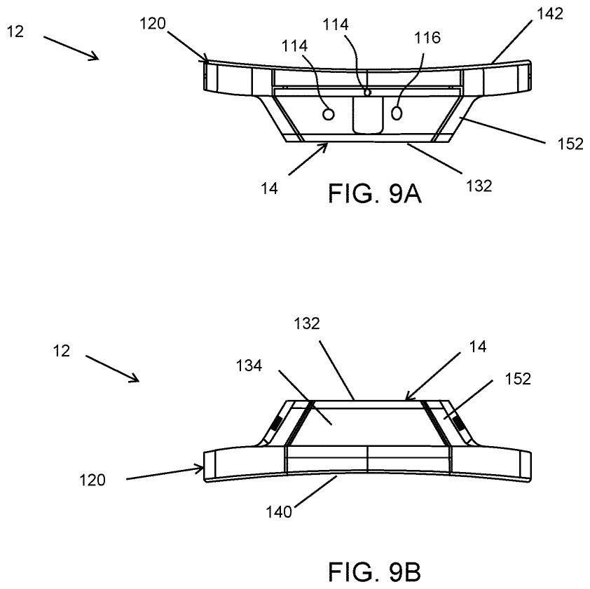

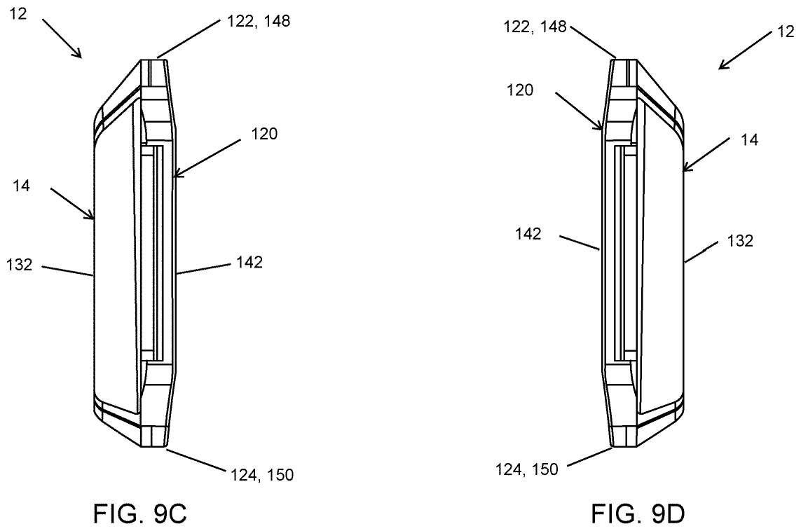

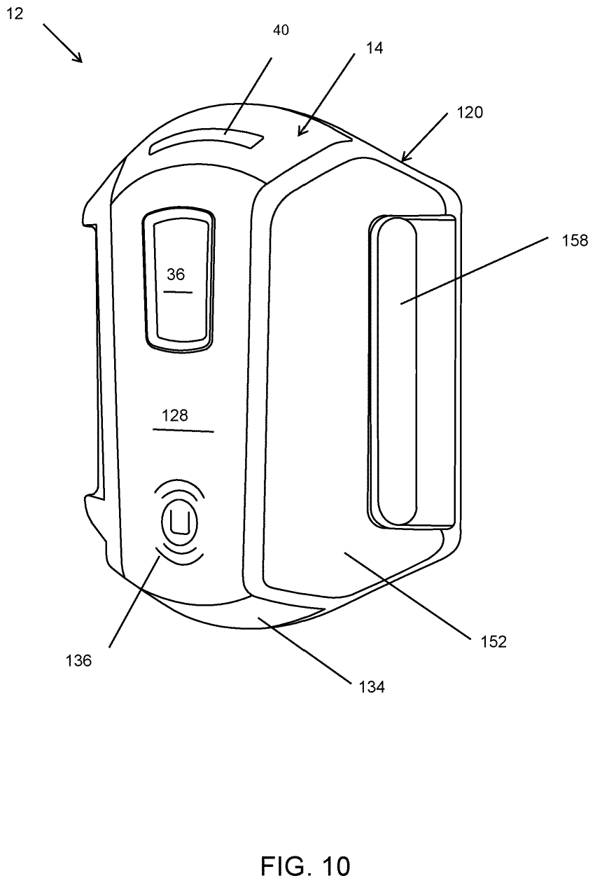

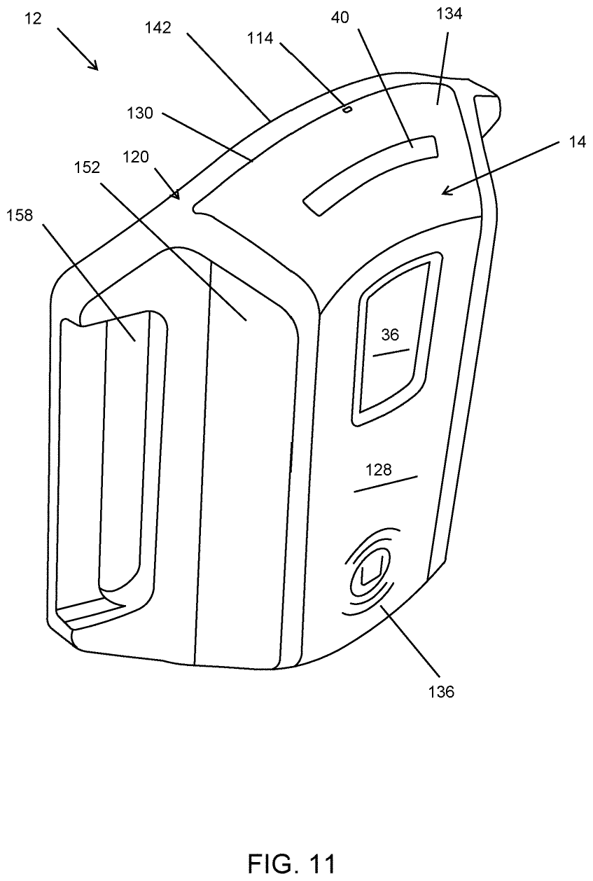

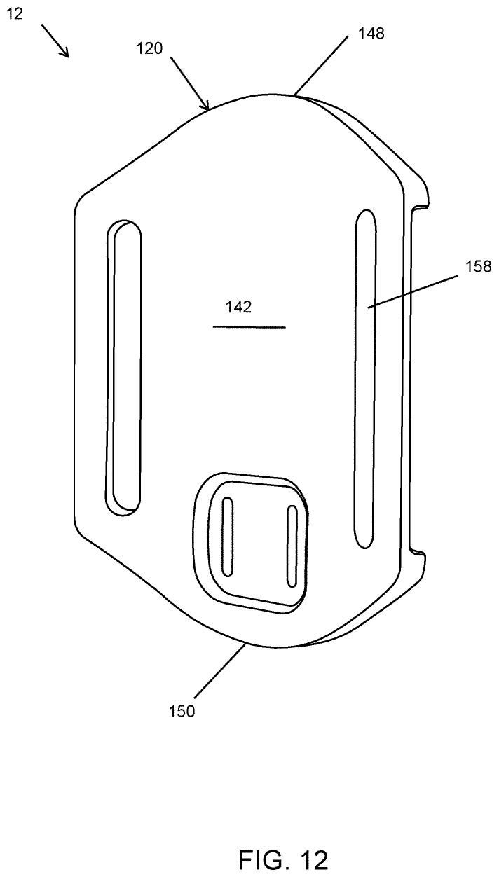

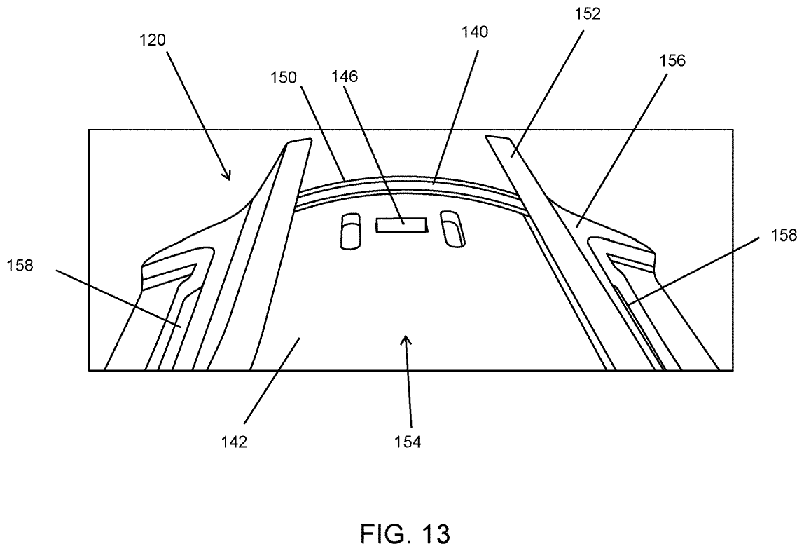

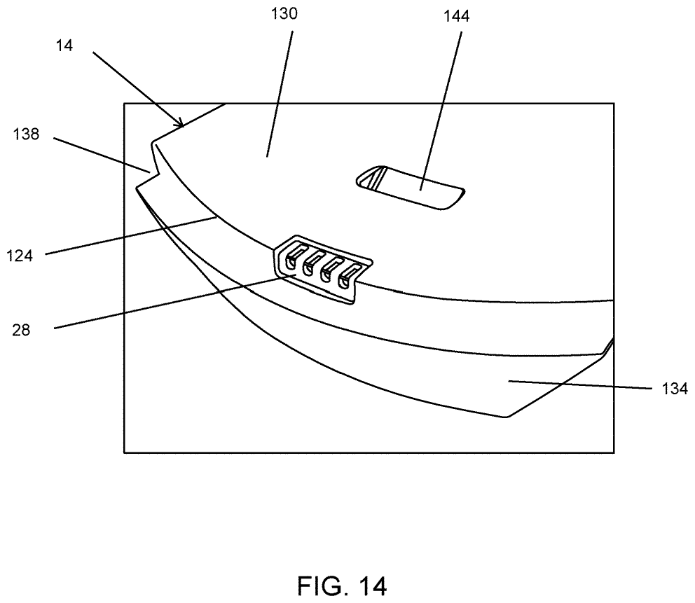

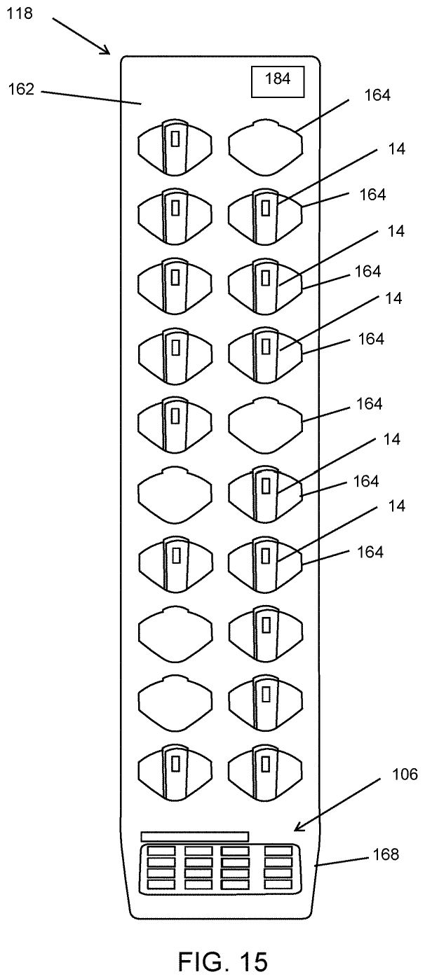

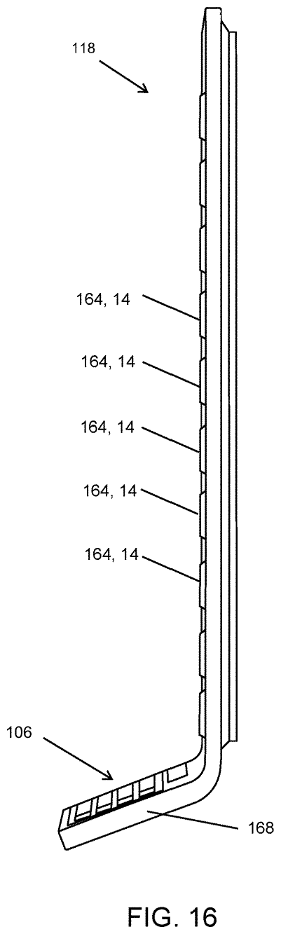

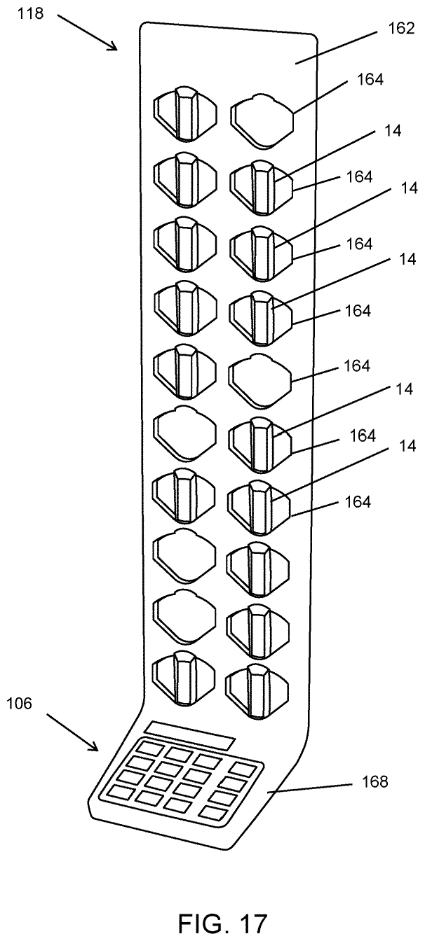

With reference to FIGS. 5-14, one configuration of a wearable device 12 is presented that includes a core 14, holster 120 and attachment member 16 among other components as is described herein.

Core:

Core 14 is formed of any suitable size, shape and design and is configured to house the electronic components of wearable device 12 and fit in and be held by holster 120 in a removable manner. In the arrangement shown, as one example, core 14 includes an upper end 122, a lower end 124, opposing sides 126, an exterior surface 128, a back wall 130 and a forward wall 132. In the arrangement shown, as one example, the size and shape of core 14 narrows slightly as it extends from upper end 122 to the lower end 124. This slight narrowing facilities the insertion of core 14 within holster 120 and ensures that core 14 may be held within holster 120 in a removable manner while ensuring that the core 14 does not come out of holster 120 in an unintentional manner. Also, in the arrangement shown, core 14 slightly narrows as it extends from the back wall 130 to the forward wall 132 so as to also facilitate easy insertion within holster 120 while preventing unintentional removal of core 14 from holster 120.

More specifically, in one or more arrangements, as is shown, the forward wall 132 and back wall 130 narrow slightly toward one another as they extend from upper end 122 to lower end 124 such that the lower end 124 is slightly narrower or slightly smaller in stature than the upper end 122. Similarly, opposing sides 126 of core 14 narrow slightly toward one another as they extend from upper end 122 to lower end 124 such that the lower end 124 is slightly narrower or slightly smaller in stature than the upper end 122.

Also, as is shown, opposing sides 126 angle toward one another as they extend from back wall 130 to forward wall 132. Such that the forward wall 132 or forward side of core 14 is slightly narrower or slightly smaller in stature than the back wall 130 or back side of core 14. In one or more arrangements, as is shown, the shape of core 14 slightly curves or contours so as to comfortably fit around the worker's arm. In this arrangement, the back surface of the back wall 130 has a slightly concave shape and the forward wall 132 has a slightly convex shape. This slightly curved or arcuate shape makes core 14 slightly more comfortable to wear. In an alternative arrangement, the forward wall 132 and/or back wall 130 are relatively flat or straight or not curved whereas the back wall of the holster 120 is curved in a concave manner thereby providing a comfortable feel for worker 102.

Also, as is shown, the upper end 122 and lower end 124 of core 14 include end walls 134. The opposing end walls 134 angle toward one another as they extend from back wall 130 to forward wall 132. That is, the upper positioned end wall 134 connects at its upper end to back wall 130 and at its sides to the upper end of sides 126 and extends slightly downward therefrom until connecting at its lower end to the upper end of forward wall 132. Similarly, the lower positioned end wall 134 connects at its lower end to back wall 130 and at its sides to the lower end of sides 126 and extends slightly upward therefrom until connecting at its upper end to the lower end of forward wall 132.

In the arrangement shown, core 14 is relatively small and has a low profile with a smooth exterior surface 128. The small size and smooth exterior surface 128 and configuration of core 14 helps to prevent the wearable device 12 from being in the way while being worn and further prevents the wearable device 12 from being hung-up or caught during use thereby causing a safety issue itself.

In the arrangement shown, as one example, the exterior surface 128 of the core 14 includes indicia 136 thereon. Indicia 136 can be any visual indication such as a logo or design, a model number, a unit number, the ID 44 of that particular core 14, instructions, lost and found information, owner info, or any other information. This indicia 136 may be included on the forward wall 132, which is outwardly facing and visible to others, or indicia 136 may be on back wall 130, sides 126, upper or lower end walls 134 or on any other portion of core 14. The inclusion of indicia 136 may improve the ease of use of system 10 by allowing for quick visual identification of core 14.

In one or more arrangements, as is shown, the upper positioned end wall 134 includes visual indicator 40 therein. In the arrangement shown, as one example, this visual indicator 40 is a transparent or semitransparent component positioned in the exterior surface 128 of core 14 that is positioned to cover or operably connect to a light or LED housed within the hollow interior of core 14, which is configured to cover the light or LED to protect it during wear while facilitating the transport of light generated by the light or LED through the material of core 14 so that it can be visually seen by the worker 102 as well as others around the worker 102. While only a single visual indicator 40 is shown in core 14, any number of visual indicators 40 are hereby contemplated for use. While the visual indicator 40 is shown in the upper positioned end wall 134, it is hereby contemplated for use that the visual indicator 40 may be positioned in any portion of core 14.

In one or more arrangements, the transparent component of visual indicator 40 may double as a light pipe 116 for light sensor 30D, or alternatively, this component is separated into two components or portions, with one component or portion serving to transport light from the light or LED to the exterior to serve as a visual indicator and the other component or portion serving as the light pipe 116 to transfer light from the exterior of core 14 to the light sensor 30D. In an alternative arrangement, a separate light pipe 116 is positioned in the exterior surface 128 of core 14 and facilitates the transfer of light from the environment to the light sensor 30D. Light pipe 116 is operatively connected to the light sensor 30D within core 14 and facilitates transfer of light from the environment to the light sensor 30D for tracking of light conditions around the worker 102.

In one or more arrangements, as is shown, the upper positioned end wall 134 includes one or more openings 114 therein. In the arrangement shown, as one example, one or more openings 114 provide a passageway through the material of core 14 thereby providing access to the sensors 30 held within core 14, such as sound sensor 30A, air quality sensor 30E or any other sensor 30 that requires access to air for sensing purposes. While only a single opening 114 is shown in core 14, any numbers of openings 114 are hereby contemplated for use. While the opening 114 is shown in the upper positioned end wall 134, it is hereby contemplated for use that the opening(s) 114 may be positioned in any portion of core 14.

In the arrangement shown, core 14 includes event trigger 36 therein. Event trigger 36 is formed of any suitable size, shape and design and is configured to be engaged by the worker 102 whenever an accident, near miss or notable event occurs. Once engaged, the event trigger 36 causes core 14 to store a high-density of information for a predetermined amount of time or period, as well as record audible information from the worker 102 and then transmit this information in a safety report or a notable event report or other report as is described herein. In the arrangement shown, as one example, event trigger 36 takes the form of a button placed in the exterior surface 128 of forward wall 132 which provides easy access to event trigger 36. In the arrangement shown, event trigger 36 is a recessed or depressed button which helps to prevent unintentional engagement of the event trigger 36 which helps to reduce the number of false-positives. In one or more arrangements, a raised ring or protective cover may be placed over or around event trigger 36 to further reduce unintentional engagement of event trigger 36. In the arrangement shown, event trigger 36 is positioned in the upper end of forward wall 132, however any other position is hereby contemplated for use.

In one or more arrangements, as is shown, the lower end of back wall 130 includes a step 138 therein. In the arrangement shown, as one example, step 138 is a notch or recess in the lower end 124 of the lower positioned end wall 134. This step 138 provides a structural feature that engages the lower end of holster 120 thereby facilitating full frictional and locking engagement between holster 120 and core 14. In the arrangement shown, step 138 is a generally right-angled groove that extends from side 126 to side 126 at the intersection of back wall 130 and lower end wall 134. A similar but opposite step 140 is positioned in the lower end of back wall 142 of holster 120. The engagement of step 138 of core 14 with the step 140 of holster 120 establishes the fully inserted position of core 14 within holster 120 and prevents the core 14 from sliding out of the lower end of holster 120.

In the arrangement shown, as one example, port 28 is positioned at or in association with step 138. In the arrangement shown, as one example, port 28 includes a plurality of conductive pins that are accessible at the lower end of back wall 130. The pins of port 28 facilitate charging of the power source 26 within core 14 when core 14 is plugged into charging base 118. The pins of port 28 facilitate data-transfer from memory 20 to the other components of system 10 when core 14 is plugged into charging base 118. The position of port 28 in the lower end of back wall 130 at step 138 provides protection for the pins of port 28 when core 14 is fully inserted within holster 120. This is because, when core 14 is held within holster 120, port 28 is covered by the back wall 142 and step 140 of holster 120.

A detent 144 is also positioned in the lower end of back wall 130. Detent 144 is any device or component that helps to facilitate locking but removable connection of core 14 to holster 120. In the arrangement shown, detent 144 of core 14 is an angled recess that is configured to receive a corresponding detent 146 positioned in the lower end of back wall 142 of holster 120. In the arrangement shown, as one example, detent 146 in the back wall 142 of holster 120 is angled protrusion that fits with close and tight tolerances and frictional engagement within the detent 144 of core 14 when core 14 is fully inserted within holster 120. Any number of detents 144, 146 are hereby contemplated for use as is any size, shape and design for detents 144, 146.

Holster:

Holster 120 is formed of any suitable size, shape and design and is configured to house and hold core 14 therein in a removable manner while core 14 is worn by a worker 102. In the arrangement shown, as one example, holster 120 includes an upper end 148, a lower end 150, opposing side walls 152, and a back wall 142 that form an opening 154 that is sized and shaped to receive core 14 therein. In the arrangement shown, as one example, the size and shape of opening 154 of holster 120 narrows slightly as it extends from upper end 148 to the lower end 150 in conforming shape with the exterior surface 128 of core 14. This slight narrowing facilitates the insertion of core 14 within holster 120 and ensures that core 14 may be held within holster 120 in a removable manner while ensuring that the core 14 does not come out of holster 120 in an unintentional manner. Also, as is shown, opposing side walls 152 angle toward one another as they extend from upper end 148 to lower end 150. This causes the opening 154 therein to be a slightly narrower or slightly smaller at the lower end 150 of opening 154 as opposed to the upper end 148.

In one or more arrangements, as is shown, the shape of holster 120 slightly curves or contours so as to comfortably fit around the worker's arm. In this arrangement, the back surface of the back wall 142 has a slightly concave shape. This slightly curved or arcuate shape makes holster 120 slightly more comfortable to wear.

In the arrangement shown, holster 120 is relatively small and has a low profile with a smooth exterior surface 156. The small size and smooth exterior surface 156 and configuration of holster 120 helps to prevent the wearable device 12 from being in the way while being worn and further prevents the wearable device 12 from being hung-up or caught during use thereby causing a safety issue itself.

In one or more arrangements, as one example, the exterior surface 156 of the holster 120 includes indicia 136 thereon. Indicia 136 can be any visual indication such as a logo or design, a model number, a unit number, the ID 44 of that particular holster, the owner's name, instructions, lost and found information, or any other information. This indicia 136 may be included on the on any portion of holster 120.

In one or more arrangements, as is shown, the lower end of back wall 142 includes a step 140 therein. In the arrangement shown, as one example, step 140 is a generally right angled protrusion in the lower end 150 back wall 142. This step 140 provides a structural feature that engages the lower end of core 14 thereby facilitating full frictional and locking engagement between holster 120 and core 14. In the arrangement shown, step 140 is a generally right-angled protrusion that extends from side wall 152 to side wall 152 at the intersection of back wall 142 and side walls 152 at the lower end 150 of holster 120. A similar but opposite step 138 is positioned in the lower end of core 14. The engagement of step 138 of core 14 with the step 140 of holster 120 establishes the fully inserted position of core 14 within holster 120 and prevents the core 14 from sliding out of the lower end of holster 120.

In one or more arrangements, a detent 146 is also positioned in the lower end of back wall 142. Detent 146 is any device or component that helps to facilitate locking but removable connection of core 14 to holster 120. In the arrangement shown, as one example, detent 146 of holster 120 is an angled protrusion that is configured to engage and be received within a corresponding detent 144 positioned in the lower end of back wall 130 of core 14. In the arrangement shown, as one example, detent 146 in the back wall 142 of holster 120 is angled protrusion that fits with close and tight tolerances and frictional engagement within the detent 144 of core 14 when core 14 is fully inserted within holster 120. Any number of detents 144, 146 are hereby contemplated for use as is any size, shape and design for detents 144, 146.

Holster 120 is configured to be connected to worker 102 by any manner, method or means. In one or more arrangements, as is shown, holster 120 includes an opening 158 positioned at each opposing side of holster 120. These openings 158 are configured to receive or connect to a portion of attachment member 16. In the arrangement shown, as one example, attachment member 16 is an elastic band that extends between opposing ends 160. In this example arrangement, the ends 160 of bands 16 are passed through the openings 158 of holster 120 and the band is tightened on itself by way of the frictional engagement of a hook-and-loop arrangement (such as Velcro® or the like systems) buttons, snaps, or any other manner or method of connecting two components together. In this way, holster 120 and core 14 are comfortably connected to worker 102. In an alternative arrangement, the worker 102 can pass their belt though the openings 158 and attach the holster 120 and core 14 in that manner.

In an alternative arrangement, instead of holster 120 having a band that serves as an attachment member 16, attachment member 16 is a clip that can be clipped onto a user's shirt, helmet, belt or any other piece of clothing or equipment.

It has been found that workers 102 like having their own bands (attachment devices 16) and their own holsters 120. This is because the worker 102 actually physically engages these components. By having personal bands and holsters 120 this is more sanitary and comfortable for the workers 102. In addition, by separating the core 14, holster 120 and attachment member 16 band, this allows for replacement of the core 14, holster 120 and attachment member 16 band separately. That is, if one of these components fails or wears out (as is often the case with an elastic band as the attachment member 16) this single component of the system 10 can be replaced without throwing away the other components.

Themed Wearable Devices:

In one or more arrangements, the attachment member 16, holster 120 and core 14 are colored with the colors of the companies that use them and include the logos or other indicia of the companies that use them. This provides a fun appeal to the system 10, and also makes it easier to identify who the owner of the components are. In another arrangement, the worker 102 can order custom colored or themed holsters 120, bands 16 and/or cores 14, such as in the motif of their favorite sports team or the like.

Charging Base 118:

In one or more arrangements, system 10 includes a charging base 118. Charging base 118 is formed of any suitable size, shape and design and is configured to receive, charge and transfer information from and to cores 14. In the arrangement shown, as one example, charging base 118 includes a back wall 162 that includes a plurality of sockets 164 that are sized and shaped to receive cores 14 therein. When cores 14 are placed within sockets 164, cores 14 are charged by charging base 118 and data transfer occurs between core 14 and charging base 118 and the other components of the system 10.

Charging base 118 also includes a user interface 106, which in the arrangement shown is included in a lower wall 168. User interface 106 provides the ability for the workers 102 to interact with the charging base 118 and may include a plurality of sensors, a key pad, a biometric scanner, a touch screen or any other input for information. As one example, at the beginning of a shift, a worker 102, with or wearing their own personal holster 120 engages the charging base 118 by biometrically scanning in with a finger or thumb print, a retinal scan, facial recognition, voice recognition or the like or any combination thereof; or alternatively, the worker 102 types in their name, worker 102 ID number, swipes a worker 102 ID card, scans in using their phone or any other manner or method of associating their personal identification with the system 10.

Upon receiving this information, charging base 118 and system 10 identifies the worker 102 and allocates a core 14 held within the charging base 118 that is fully charged, or has the highest charge among the cores 14, and assigns that core 14 to that worker 102 by illuminating the core 14, illuminating the socket 164 that the core 14 is held in, or providing the socket number to the worker 102 or by identifying which core 14 the worker 102 is to take by any other manner, method or means. Also, in association with this process, system 10 programs core 14 with the proper threshold levels and other information that is particular to that worker's job. For instance, for a worker 102 in a heavy industrial position that wears external protective gear (such as earmuffs) the thresholds will be substantially different than the thresholds for a worker 102 in a light clerical role that does not wear any protective gear. This ensures that proper safety thresholds are identified for each worker 102 in each role. This ensures that unnecessary safety concerns are maintained at a minimum.

Once the proper core 14 has been identified to the worker 102, the worker 102 retrieves that core 14 from the charging base 118, slides the core 14 into their holster 120 and the worker 102 begins their shift and the core 14 begins recording information in the manner described herein.

At the end of the shift, the worker 102 returns the core 14 to the charging base 118. Once the core 14 is plugged into a socket 164, the charging base 118 begins charging the core 14 and begins retrieving data from the core 14 for distribution into the system 10 and saving into database 68 among other uses as is described herein. The system 10 may also updates the software or firmware on the core 14 and prepares the core 14 for another use.

In one or more arrangements, after turning in the wearable device 12 at the end of their shift, the worker 102 is provided with a log of all items that were sensed as potential accidents or near misses and/or notable events. The information related to each of these potential accidents or near misses and/or notable events is provided to the worker 102 such as time, position, temperature, light level, air quality, volume, CO level, the audible recording or converted text of the contemporaneous recording of the incident or notable event. The worker 102 is then provided the opportunity to confirm or deny whether an accident or near miss or notable event actually occurred, and provide additional information regarding the potential accident or information or notable event. This provides the worker 102 the opportunity to clarify the record and provide additional information.

In one or more arrangements, charging base 118 includes its own communication equipment, such as a cellular communication module. In this arrangement, charging base 118 can communicate completely independently of the internet service or other communication service utilized by the manufacturing facility. This independence ensures that the charging base 118 has the best possible ability to get accurate and timely information to the database 68, electronic network 104, management software 108 and other components of the system 10, so as to ensure timely and accurate reporting of safety events, near misses, accidents and notable events. This independent communication structure also prevents the addition of charging base 118 and system 10 from being a drag on the internet or other communication structure of the manufacturing facility. This independent communication also ensures that the charging base 118 itself can send out text messages and emails directly to the safety manager 112 or others without delay when an accident occurs. In an alternative arrangement, the charging base 118 connects to the internet or communication service utilized by the manufacturing facility. In yet another alternative arrangement, the charging base 118 includes both an independent communication structure as well as connecting to the internet or communication service utilized by the manufacturing facility which provides the benefits of redundancy and back-up in the event that one system is not working.

To be clear, core 14 may transfer data in any of a number of manners. In one or more arrangements, periodically during use core 14 transmits information to other components of the system 10. This may occur at a convenient time, such as when the core 14 establishes a strong wireless connection with other components of the system 10, or when there is low utilization on the system 10, or the like. In another arrangement, core 14 stores data on its memory 20 and transmits this data to other components of the system 10 when core 14 is plugged into charging base 118, directly into an internet-connected lead (such as an Ethernet cable, or mini-Ethernet cable, or the like). In another arrangement, core 14 transfers data both periodically through a wireless connection to other components as well as when core 14 is plugged into charging base 118 or another internet-connected device. In this way, the system 10 and/or core 14 can transmit information in the most efficient manner and in accordance with the urgency of the information. That is, urgent information, such as a safety issue, may be transmitted immediately, whereas mundane data collected for data mining purposes may be stored and transmitted in a more-efficient and less burdensome manner when core 14 is plugged into charging base 118. This flexibility of data transfer provides efficiencies and helps the system 10 operate in the most efficient manner possible.

Outdoor Version:

While the arrangements described primarily herein discuss use of core 14 and/or system 10 within a manufacturing facility where core 14 communicates using Wi-Fi or other close-proximity wireless communication technology, it is contemplated that in other arrangements it is desirable to use the system 10 outside of the constraints of a single building or a single manufacturing facility or campus. In these arrangements, core 14 is equipped with its own cellular communication module which facilitates the operation of the system 10 described herein without the need to be constrained to any particular geographic area. In this arrangement, core 14 communicates with system 10 in the manners described herein through communication with existing third-party cellular towers, much in the same way that a conventional cellular phone communicates with these towers. This information is then routed through the electronic network 104 to database 68 and the other components of system 10.

This arrangement is desirable for companies that have a dispersed workforce such as package delivery companies such as Fed-Ex and UPS, railroads, companies that do on site repair and installation such as heating and air conditioning companies and plumbing companies, or any other company with a dispersed workforce that is not housed or constrained within a building or campus. Other than having cellular communication capabilities, this outdoor version of the core 14 operates in a similar if not identical manner to that described herein and facilitates the accomplishment of the same if not identical objectives.

Workers' Compensation Insurance and Safety OSHA Audit:

One benefit of using system 10 is that the information collected by wearable devices 12 and/or data metrics derived therefrom may be used to facilitate assessment of safety risks faced by workers and determination of policy premiums that are accurately align with the safety risks. Additionally or alternatively, in one or more arrangements, system 10 may use information collected by wearable devices 12 and/or data metrics derived therefrom to show compliance in OSHA audits and therefore may reduce the liability of the company. Additionally or alternatively, in one or more arrangements, system 10 may use information collected by wearable devices 12 and/or data metrics derived therefrom as evidence in worker compensation claims and therefore may reduce the liability of the company. Additionally or alternatively, in one or more arrangements, when an accident does occur, the system 10 is configured to format information and data collected by the data to be entered directly into the required fields of an OSHA accident report. This saves time, money and ensures that the proper and thorough information is provided.

### Monitoring System 60:

In one or more shown arrangements, system 10 includes a monitoring system 60. Monitoring system 60 is formed of any suitable size, shape, design and is configured to receive information recorded by wearable devices 12 (e.g., via charging base 118 and/or electronic network 104) and store the information and/or aggregate data derived therefrom. In the arrangement shown, monitoring system 60 includes a database 68 and a data processing system 70 communicatively connected to the database.

Database 68:

Database 68 is formed of any suitable size, shape, design and is configured to facilitate storage and retrieval of data. In the arrangement shown, as one example, database 68 is local data storage connected to data processing system 70 via electronic network 104. However, embodiments are not so limited. Rather, it is contemplated that in one or more arrangements, database 68 may be remote storage or cloud based service communicatively connected to data processing system 70 via one or more external communication networks.

In some various arrangements, information recorded by wearable devices 12 may be to database 68 for storage directly (e.g., over electronic network 104) from wearable devices. Additionally or alternatively, in some various arrangements, information recorded by wearable devices 12 may be to database 68 for storage indirectly (e.g., by charging base and/or data processing server.

Data Processing System 70:

Data processing system 70 is formed of any suitable size, shape and design and is configured to facilitate receipt, storage, and/or retrieval of information in database 68, execution of analytics software 80, execution of the management software 108, providing of a user interface 106, and/or implementation of various other modules, processes or software of system 10.

In one or more arrangements, for example, such data processing systems includes a circuit specifically configured and arranged to carry out one or more of these or related operations/activities. For example, data processing system 70 may be discreet logic circuits or programmable logic circuits configured and arranged for implementing these operations/activities, as shown in the figures, and/or described in the specification.

In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions which may be executed by a computer (or other electronic device) to perform these operations/activities.

Analytics Processes 80:

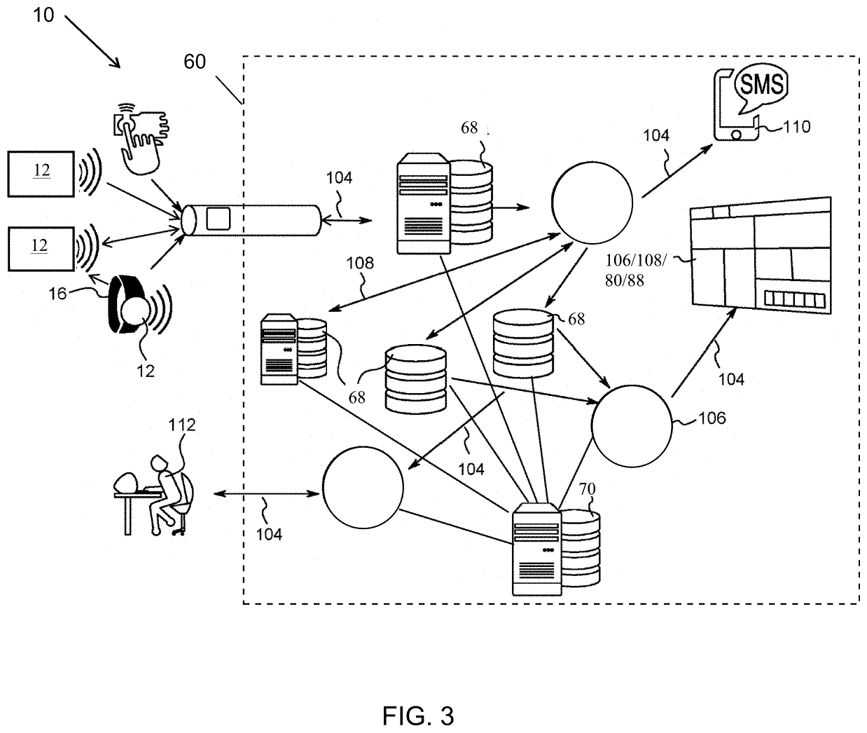

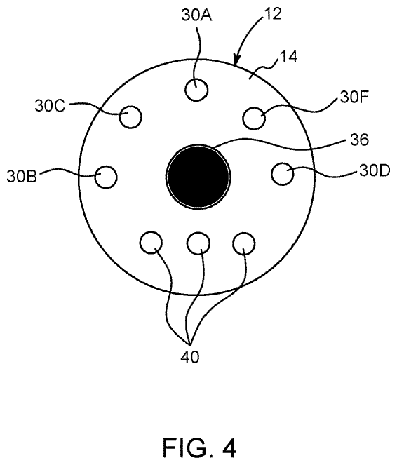

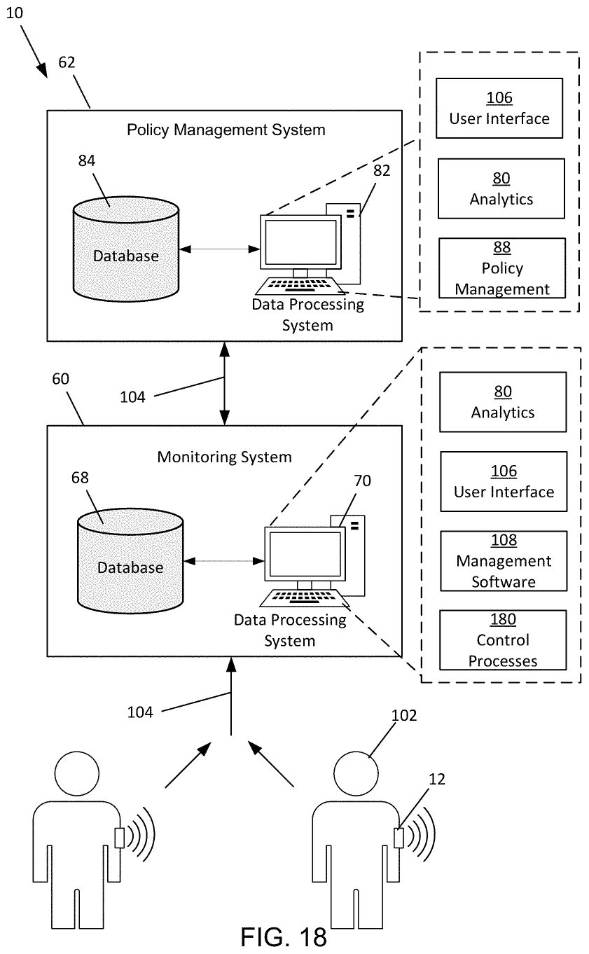

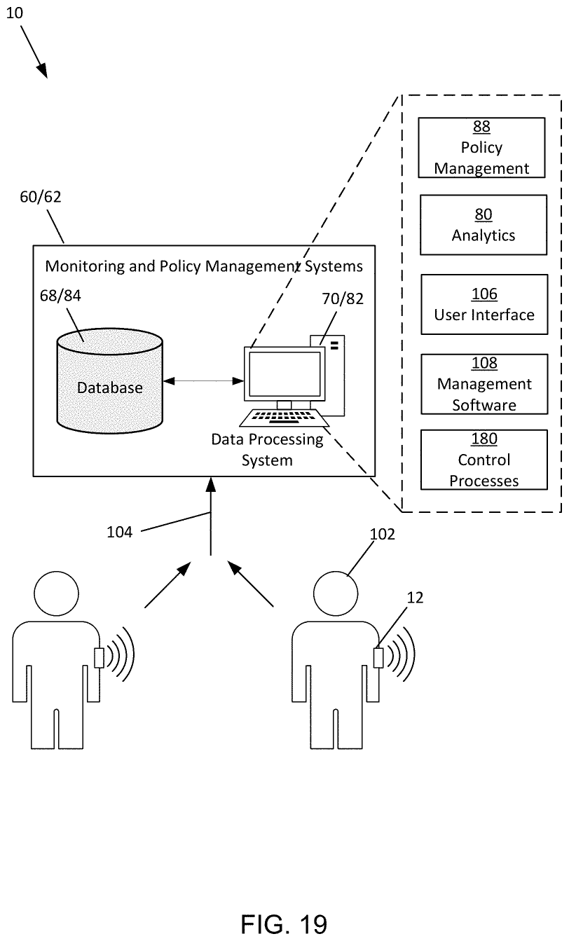

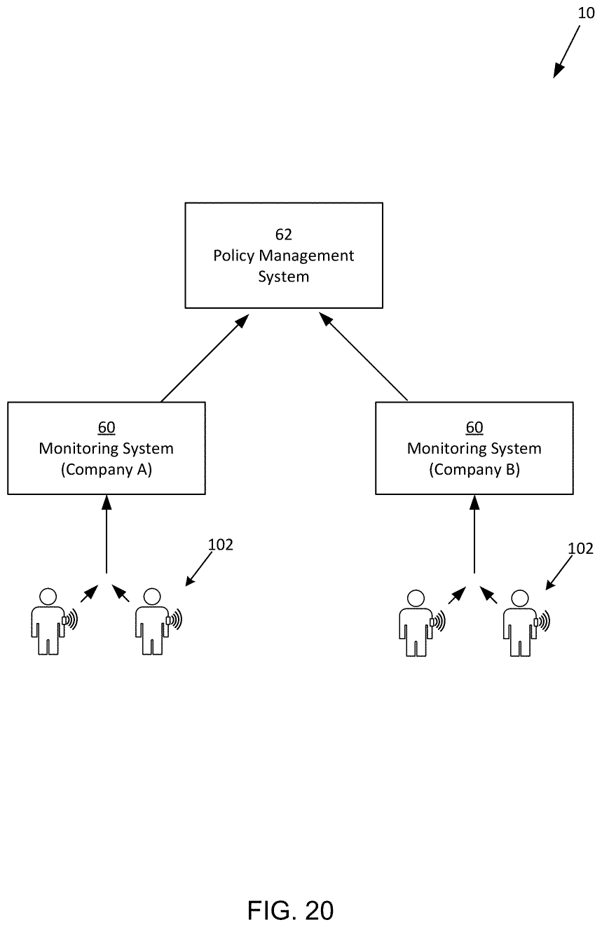

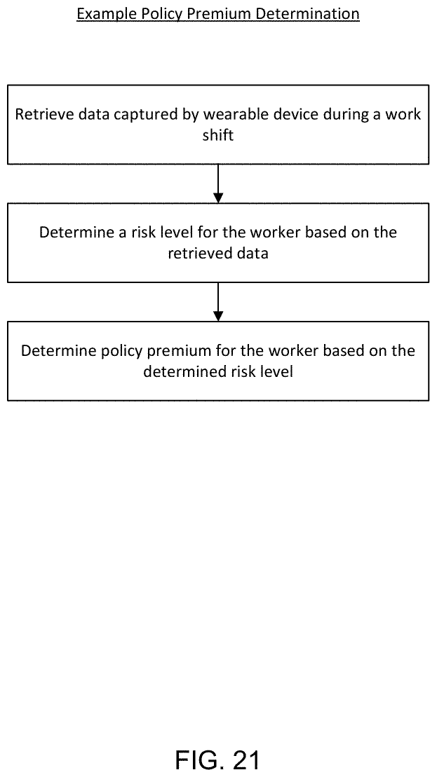

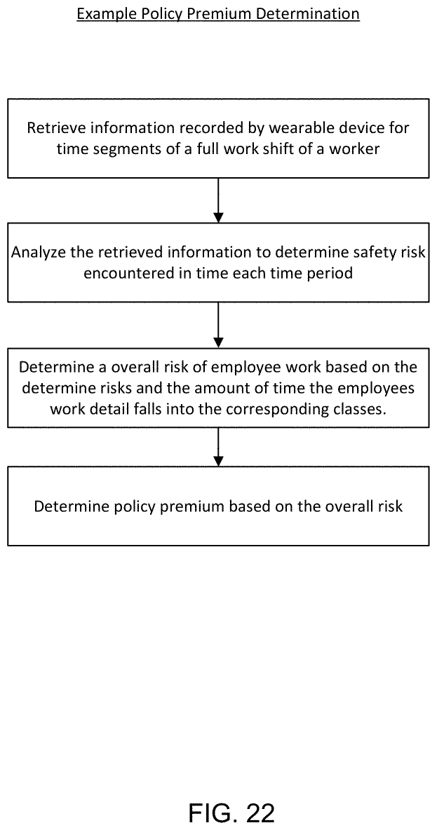

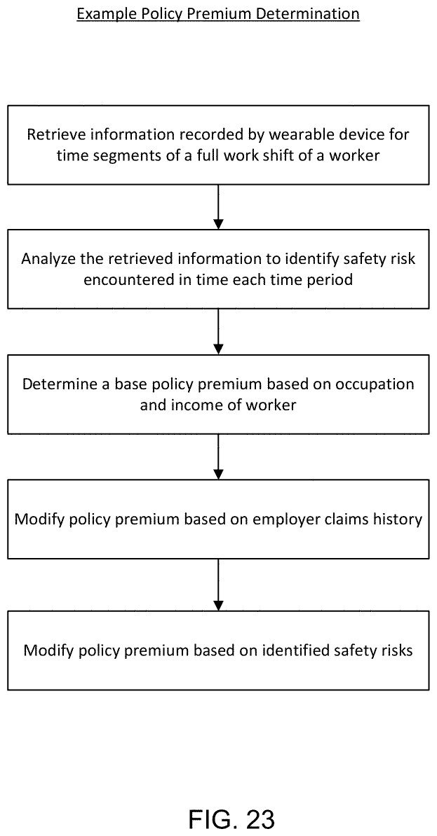

In some example arrangements, data processing system 70 is configured to perform various tracking, analytics processes 80, and/or other operations described using data received from wearable devices 12 and/or data stored in database 68. In the example arrangement shown in FIG. 3, data processing system 70 is illustrated as being separate from management software 108 and user interface 106. However, the embodiments are not so limited. In various implementations, analytics processes 80 may be executed alongside management software 108 and user interface 106 on data processing system 70 as shown in FIGS. 18 and 19. Additionally or alternatively, data analytics 80 and/or other processes performed by data processing system 70 may in whole or in part be incorporated into and form part of management software 108.

Identifying High Risk Events:

In one or more arrangements, analytics processes 80 are configured to process information received from wearable devices 12 and/or data stored in database 68 to derive additional data metrics pertinent to assessment of safety risk of workers 102. In an example arrangement, analytics processes 80 may be configured to evaluate the data using a classifier or state machine that is trained to identify high risk events (e.g. accidents, trips/falls, near misses, and/or other events indicative of injury or heightened safety risk) that are not directly identified and reported by wearable devices 12. In some arrangements, identified instances may be logged to create a history of high risk events for a worker 102. Such historical data may be useful in assessing safety risk faced by a worker 102 during a work shift and calculating insurance policy premiums.

Location Based Risk Assessment:

In one or more arrangements, information from a plurality of wearable devices 12 indicating positions of workers 102 over a period of time is aggregated into database to facilitate assessment of risks faced by workers using software, algorithms, artificial intelligence and/or any other data processing systems. For example, in one or more arrangements, worker 102 risk may be determined based on frequency and/or duration of time that workers 12 are present in high-risk area.

In one example arrangement, analytics processes 80 are configured to evaluate location data recorded by wearable devices 12, for example, to determine higher risk area and lower risk areas of a workplace. With workers 102 using wearable devices 12 and with wearable devices 12 tracking the position of the worker 102, while sampling the environmental conditions surrounding workers 102, analytics processes 80 may develop maps of actual accidents and near misses, which is information that was never before easily collected. This information can be used to predict where future accidents or near misses are likely to occur. This information also can be used to inform safety managers 112 of the areas of manufacturing facility 100 that pose the highest risk.

In one or more arrangements, analytics processes 80 are configured to develop what are known as heat maps which can be used to show the concentration of certain conditions. That is, a heat map can be generated to indicated area that may pose a higher safety risk, for example, areas that the most traveled or busiest, that are the noisiest, that have the highest contaminants, that are in close proximity to dangerous equipment, that have extreme or hazardous temperatures, and/or that have low light levels. These heat maps provide insight into the conditions of the manufacturing facility that are actually experienced by the workers 102 themselves and provide insight never before obtained. These heat maps may be used to assess position data of a worker 102 during a work shift to identify and log instances and/or durations of time in which the worker 102 is in an area that poses a higher risk of injury. Identification of these instances may be used to facilitate assessment of safety risk faced by a worker 102 during a work shift and/or calculating insurance policy premiums.

Additionally or alternatively, heat maps can be used to improve the conditions of the manufacturing facility. For instance, hallways and doorways can be widened at the areas of highest traveled areas, additional lighting can be added to the areas of lowest light, additional ventilation can be added to the areas of worst air quality, additional heating or cooling can be added to areas with the highest or lowest temperature, or any other corrective action can be provided. This ensures that the highest level of impact is provided for each investment. In one or more arrangements, the system 10 also provides a feed-back loop for determining how effective the corrective action was by comparing heat maps before the corrective action and after the corrective action.

When specific areas of the manufacturing facility 100 are identified as the most likely to have an accident, information collected by sensors 30 of wearable devices 12 can be used to determine the root cause of the accidents or near misses, such as low light levels, or high temperatures or low temperatures, or high volumes or high pitched volumes, too much congestion in high traffic areas or any other condition. Also, correlations can be generated between the great amount of aggregate data and information collected by wearable devices 12 and accidents or near misses to reveal further information that can be used to reduce or eliminate accidents or near misses in the future.

The information from wearable devices 12 and the correlations between the information and increased likelihood of accidents or near misses can be used to implement solutions, such as increasing lighting in accident-prone areas with insufficient lighting; widening hallways in accident prone congested areas, moving noisy tooling in accident prone areas with high volume levels, or the like.

Assess Based on Worker Access to Company Resources

In one or more arrangements, information from a plurality of wearable devices 12 indicating accesses of company resource (e.g., high risk equipment) by workers 102 over a period of time is aggregated into database to facilitate assessment of risks faced by workers using software, algorithms, artificial intelligence and/or any other data processing systems. For example, in one or more arrangements, worker 102 risk may be determined based on frequency and/or duration of time that workers 12 utilize high-risk company resources.

In one or more arrangements, system 10 may be configured to control access to and/or operation of company resources using one or more access control mechanisms. For instance, in in some various arrangements, system 10 is configured to control one or more remote locking devices 178 (not shown) to control access to and/or operation of company resources. Remote locking devices 178 are formed of any suitable size, shape and design and are configured to prevent physical access to or use of company resources when in a locked state, and permit physical access to or use of the company resources when in an unlocked state. Remote locking devices 178 may be used to restrict access and use of various company resources including but not limited to, for example, facilities, rooms, lockers, drawer, cabinets, elevators, doors, tools, machinery, computing systems, digital resources and/or phones to name a few. In one or more arrangements, remote locking device 178 has a communication circuit configured to wirelessly communicate (or over wired communication) with monitoring system 60 and/or other component(s) of system 10 via electronic network 104. In one or more arrangements, remote locking device 178 also includes a locking mechanism. The locking mechanism is formed of any suitable size, shape and design and is configured to restrict access or operation to a particular resource in a locked state and permit access to the resource in the unlocked state.

In some various different arrangements, monitoring system 60 and/or other component(s) of system 10 are configured to implement one or more control processes 180 configured to control access to and/or operation of company resources using various processes. For example, in one or more arrangements, control processes 180 is configured to monitor location of workers 102 using data gathered from wearable devices 12 during a work shift and perform various operations in response to workers being in specific locations.

In some various different arrangements, location of workers 102 may be monitored using various means and/or methods. For instance, in one or more arrangements, wearable devices 12 of workers 102 are configured to periodically and/or continuously communicate data to control processes 180 indicating location of wearable devices 12 of workers 102. Additionally or alternatively, in one or more arrangements, control processes 180 may be configured to monitor location of workers by receiving notifications when wearable devices 12 are in close proximity to various device (e.g., remote locking devices 178).

In one or more arrangements, control processes 180 maintain a set of rules in a database 68/84 listing of geographic locations or zones and actions to be performed when workers 102 are determined to be located in the specific geographic locations or zones. Rules may be modified by an authorized user via user interface 106, for example. As one illustrative example, the rules in database 68/84 may cause control processes 180 to cause a remote locking device 178 to turn off and/or disable an inherently dangerous machine in response to location data indicating a worker 102 is in close proximity to the machine.

In one or more arrangements, control processes 180 may be configured to perform different actions or provide different levels of access to different workers 102. For example, in one or more arrangements, control processes 180 are configured to maintain a listing of workers 102 and respective access and use permission in database 68/84. Permitted accesses and uses may be modified by an authorized user via user interface 106, for example. As one illustrative example, in one or more arrangements control processes 180 are configured to provide user specific access to company resources.

As one example implementation, when a safety device 12 is in close proximity to remote locking device 178 while in a locked state, safety device 12 transmits the unique ID 44 of the safety device 12 to remote locking device 178. In response to receiving the unique ID 44, remote locking device 178 sends a query to control processes 180 to determine if the worker 102 associated with the unique ID 44 should be granted access. In response to receiving the query, control processes 180, determine the worker 102 associated with unique ID 44 and then determines from database 68/84 if the worker 102 has permission to access the resource associated with the remote locking device 178. Control processes 180 then provide a response to the remote locking device 178 indicating whether or not the worker 102 is to be permitted access. If the response indicates that the worker 102 is permitted access, the remote locking device 178 transitions to the unlocked state remains in the locked state. Otherwise, the remote locking device 178 remains in the locked state.

When transitioning to the unlocked state, some remote locking devices 178 may remain in the unlocked state for a certain period of time. For example, a remote locking device 178 connected to a door, may transition to an unlocked state for 5 seconds to permit a permitted worker 102 to open the door. Conversely, some remote locking devices 178 may be configured to remain in the unlocked state while the safety device 12 having the unique ID 44 remains in close proximity. For example, a remote locking device 178 connected to a milling machine, may remain unlocked to permit use by an authorized worker 102.

In one or more arrangements, control processes 180 are configured to track training and/or certification status of workers 102 for use of certain machines and/or equipment. For example, workers 102 may be required to complete yearly safety training to operate potentially dangerous machines. In one or more arrangements, control processes 180 may be configured to automatically update access control permission for worker 102 in response to changes in training and/or certification status. For example, control processes 180 may update access control permissions to deny a worker 102 access to a particular machine in response to determining that a certification of the worker 102 has expired. Conversely, control processes 180 may update access control permissions to permit the worker 102 access to the machine in response to determining that the worker 102 has been recertified.

Repetitive Motion Identification and Assessment:

In yet another example arrangement, analytics processes 80 are configured to analyze data of accelerometer 32 to identify repetitive motions which may lead to injury over time. Identification of repetitive motions may be helpful to identify performance of tasks that have a higher risk of injury. Identification of such tasks may be useful in assessing safety risk faced by a worker 102 during a work shift and calculating insurance policy premiums.

Additionally, identification of repetitive motions may be helpful to facilitate development and execution of measures to avoid such injury. In this example arrangement, analytics processes 80 may be configured to regularly retrieve accelerometer 32 data of workers 102 from database 68 for evaluation (e.g., daily, weekly, or monthly). After retrieving the data, analytics processes 80 processes the data using, for example a classifier or state machine that is trained to detect and group similar motion events.

In an example arrangement, after processing the data to identify similar motion events, analytics processes 80 determines a set of workers 102 in which a motion or similar group of motions is identified with high number of occurrences (e.g., exceeding a specified threshold). In this example arrangement, analytics processes 80 then flag the task performed by the workers 102 as a high risk activity.

In one or more arrangements, analytics processes 80 are configured to quantify the level of repetitive motions performed by a worker 102. For example, in one or more arrangements, analytics processes 80 may be configured to quantity repetitive motions based on the number of instances that a worker 102 performs the identified repetitive motions in a certain period of time (e.g., day, week, month). In some various arrangements, the analytics processes 80 may generate reports, e.g., tables, charts, graph, maps, showing the quantified repetitive motion, for example, for different jobs, workplace areas, different departments, groups and/or individual workers, and/or different shifts or times of day.

Physicality Assessment:

In yet another example arrangement, analytics processes 80 are configured to analyze data provided by sensors 30 to assess the physical exertion of workers 102. Jobs requiring high levels of physical exertion may be more likely to result in injury. Identification of repetitive motions may be helpful to identify jobs requiring high levels of physical exertion. In this example arrangement, analytics processes 80 is configured to quantify the total physicality of tasks performed by workers 102 based on heart rate, temperature, perspiration level, number of steps, distance traveled, accelerometer data, and/or other data acquired by sensors 30 or determined by analytics processes 80 using data analytics (e.g., the determined repetitive motion quantification). In some various arrangements, the analytics processes 80 may generate and store data metrics indicating instances in which a worker 102 exhibits high levels of physical exertion during a work shift. Such data metrics may be useful in assessing safety risk faced by a worker 102 during a work shift and calculating insurance policy premiums.

Deviation from Similar Workers

In one or more arrangements, analytics processes 80 are configured identify workers 102 in which recorded information and/or data metrics deviates from that of other workers having the same primary occupational role. Such identification of workers 102 may be useful for example to identify workers 102 whose safety risk may be atypical and not accurately represented by the average risk for the worker's primary occupational role. In one or more arrangements, analytics processes 80 may generate a report indicating workers 102 for which deviations have been identified. In some arrangements, the analytics processes 80 may send the report to a manager or insurer for review. Such reports may be useful, for example, to flag workers 102 whose indicated occupation may be inaccurate for audit.

In some arrangements, in response to identifying deviations for a set of workers 102, monitoring system 60 and/or policy management system 62 may be configured to automatically perform various additional analytics processes 80 to generate data metrics indicative of safety risk faced by the workers 102. For example, in response to identifying a worker 102 deviating from other workers 102 of the same occupation, analytics processes 80 may evaluate duties performed by the worker 102 to ensure the worker's occupation is correctly classified.

Identification of Secondary Duties Performed by Workers

It is recognized that workers 102 may perform various secondary duties and/or tasks performed by a worker 102 may pose a different risk than the worker's 102 primary occupational role. In one or more arrangements, analytics processes 80 are configured to process information received from wearable devices 12 and/or data stored in database 68 to identify and classify secondary duties being performed by a worker 102 that differ from the primary occupational role of the worker 102. As an illustrative example, in one example arrangement, analytics processes 80 are configured to retrieve and evaluate information indicative of working conditions and/or work performed by a worker 102 that is recorded in a plurality of timer periods over a full work shift.

In one example, analytics processes 80 processes the retrieved information or each time period using, for example, a classifier or state machine that is trained to identify worker 102 information matching signatures indicative of particular occupations.

In one or more arrangements, classifiers or state machines may be trained using artificial intelligence processes to evaluate stored data of all workers 102 to identify characteristics that are common to each occupation and characteristics that are distinctive from other occupations. Such characteristics may be combined to form a signature used by the classifier or state machine to recognize what occupation best matches tasks performed by workers at each of the plurality of time periods throughout a full work shift. Identification of the occupations performed in each time period may be helpful to better assess risk faced by workers 102 over an entire work shift and better determine policy premiums for the workers 102.

As an illustrative example, training of a classifier may develop a strong correlation between a traveling within a facility above a threshold speed with the occupation of driving a forklift. If analysis of stored data indicated a worker 102 having a different occupation is traveling above the threshold speed during a certain time period, analytics processes 80 may determine that the worker 102 is performing the secondary duty of driving a forklift.

Trend Analysis:

It is recognized that workers 102 tend to experience increased risk over time, often due to changes in their work environment and/or long hours in difficult conditions. As an illustrative example, a worker 102 may being to regularly work in low lighting at the end toward of a long shift. Such low lighting may present risk of fatigue and increase risk of injury. In one or more arrangements, analytics processes 80 are configured track values of the worker data stored in database 68 to identify when trends occur. In one example arrangement, in response to identifying a trend in the data, analytics processes 80 update data metrics and/or risk assessments for the worker 102. Additionally or alternatively, in response to identifying a trend in the data, analytics processes 80 trigger recalculation of insurance policy premium of the worker 102.

### Policy Management System 62:

In one or more shown arrangements, system 10 includes a policy management system 62. Policy management system 62 is formed of any suitable size, shape, design and is configured to retrieve and/or receive information from monitoring system 60 relevant to safety risks faced by workers during a work shift and determine/adjust premiums for a worker's compensation insurance policy based on the received information.

The arrangements are primarily discussed with reference to a system having a policy management system 62 operated by an insurer and remotely connected over one or more networks to monitoring system 60 located at a client company facility, for example, as shown in FIG. 18. However, the embodiments are not so limited. Rather, it is contemplated that policy management system 62 and monitoring system 60 may be implemented and located together as one system, for example, as shown in FIG. 19. Any other arrangement or distribution of system components is also contemplated.

In the arrangement shown, policy management system 62 includes a data processing system 82 and database 84. Data processing system 82 and database 84 are configured similar to data processing system 70 and database 68 of monitoring system 60. In this example arrangement, database 84 is used to store customer and insurance policy data and information received from monitoring system 60. In one or more arrangements, some or all of the analytics processes 80 are performed by data processing system 82 of policy management system 62 instead of by data processing system 70 of monitoring system 60.

Policy Management Software 88:

In this example arrangement, data processing system 82 executes policy management software 88 in addition to or in lieu of analytics processes 80. Policy management software 88 is formed of any suitable processes, methods, or function and is configured to facilitate review and/or evaluation of information and/or data metrics received from monitoring system 60 indicative of safety risks of faced by workers 102 during a work shift for determination of worker 102 risk and/or policy premiums, and/or other metric relevant to insurance based on. In an arrangement shown, as one example, such information provided by monitoring system 60 may include but is not limited to, for example, information recorded by wearable devices at various time period of a work shift, data metrics derived therefrom, and/or any other data stored in database 68/70.

Risk Assessment Using Real-Time Data:

It is recognized that workers 102 may face greater or lesser risk of injury at various times throughout a work shift. In one or more arrangements, real time data gathered by wearable devices 12 to provide an accurate assessment of risk for a work shift of a worker 102 as a whole. As used herein, information and data are referred to as being “real time” in that wearable devices 12 record the information/data for multiple different time periods to provide a full and accurate view of an actual work shift of a worker 102.

In one or more arrangements, policy management software 88 and/or analytics processes 80 are configured to retrieve and/or process information recorded at multiple time periods throughout a full work shift by wearable devices 12 to facilitate a more accurate assessment determination of policy premiums for workers. In an example arrangement, at each time period, risk is assessed by policy management software 88 based on work performed, worker 102 location, environmental conditions, identified events (e.g., accidents, trips/falls, near misses, and/or other events indicative of injury or heightened safety risk) and/or any other information. For each worker, an overall risk is determined based on the risk assessments performed in each time periods.

In one or more arrangements, after data analytics 80 analyzes worker data in database 68/84 for each time period of the work shift, policy management software 88 is configured to determine a safety risk level for each time period, for example, based on the type of work and/or identified safety hazards, high risk events, and/or any other information pertinent to safety risk of workers. Such risk level may be determined, for example, by looking up a risk level for the occupation in a table stored in database 68. In one or more arrangements, policy management software 88 may adjust the determined risk levels based on other work conditions. As one example, some jobs may pose a higher risk in the afternoon when workers may become tired and inattentive than they do in the morning when workers are well rested. As anther example, some worksite locations pose a greater safety risk when performing certain tasks (e.g., tasks requiring well light area). In one or more arrangements, the determined risk levels work performed in each time period of the work shift may be aggregated to form a risk for the full work shift of the worker 102.

Premium Determination:

Policy management software 88 may determine policy premiums using any suitable processes, methods, and/or functions. As one illustrative example, policy management software 88 may first determine an occupational risk values for a worker 102 based on income, primary occupational role of the worker 102 and any secondary occupational roles identified by analytics processes 80 as being performed by a worker 102 during a work shift (for example by looking up risk values in a table stored in database). In one or more arrangements, policy management software 88 combines the determined risk values for the occupational roles pro-rata based on the length of the time in which the worker 102 was performing each occupational role to determine a combined occupational risk. Policy management software 88 may determine a base premium rate based on the income of the worker 102 and the combined occupational risk.

In one or more arrangements, policy management software 88 adjusts the determined base premium based on companies claims experience for previous injuries. For instance, in one or more arrangements, policy management software 88 may increase the premium based on the number of previous workers' compensation claims submitted in the previous three years. In an example arrangement, policy management software 88 may look up amounts to increase in risk/premium for companies claims experience from a table stored in database 84.

In one or more arrangements, policy management software 88 further adjusts the determined base premium based on high risk indicators (e.g., safety hazards, high risk events, and/or any other information indicating risk to safety of workers) identified by analytics processes in the work shift data. High risk indicators may include but are not limited to, for example, air contaminants, high noise levels, presence in high risk areas or hot spots, high physicality levels, repetitive motions performed by worker, accidents, trips/falls, near misses, and/or other events indicative of injury or heightened safety risk). In an example arrangement, policy management software 88 may look up amounts to increase in risk/premium for identified high risk indicators from a table stored in database 84.

Once policy premium is determined and adjusted the, the updated premium for the worker 102 is stored in database 84. In the next billing cycle, the updated premium is used to for invoicing, which may require the policy holder submit payment for an increased premium or possibly receive for decreased premium. It is contemplated that in various arrangements, policy management software 88 may be configured to update policy premium at various frequencies throughout. It is contemplated that risk may be assessed and policies updated yearly, quarterly, monthly, weekly, daily, and/or any interval in between.

Dashboard Interface:

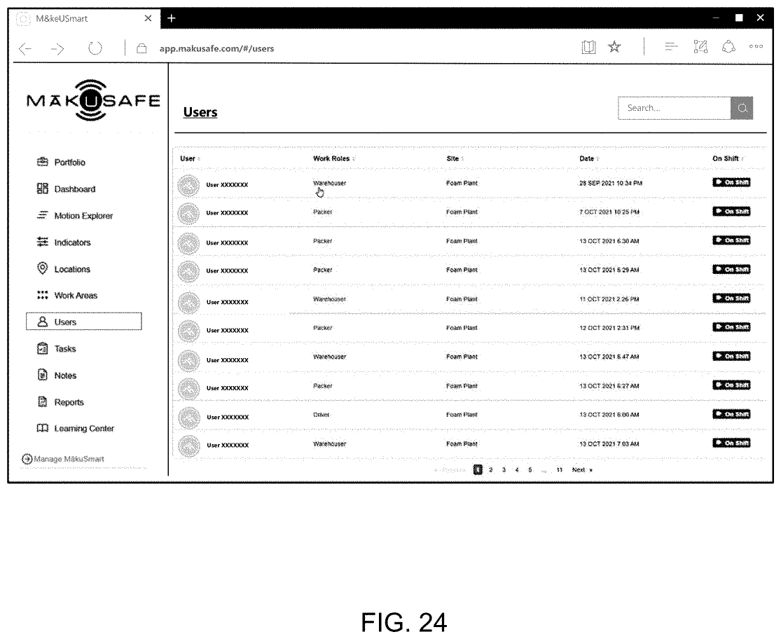

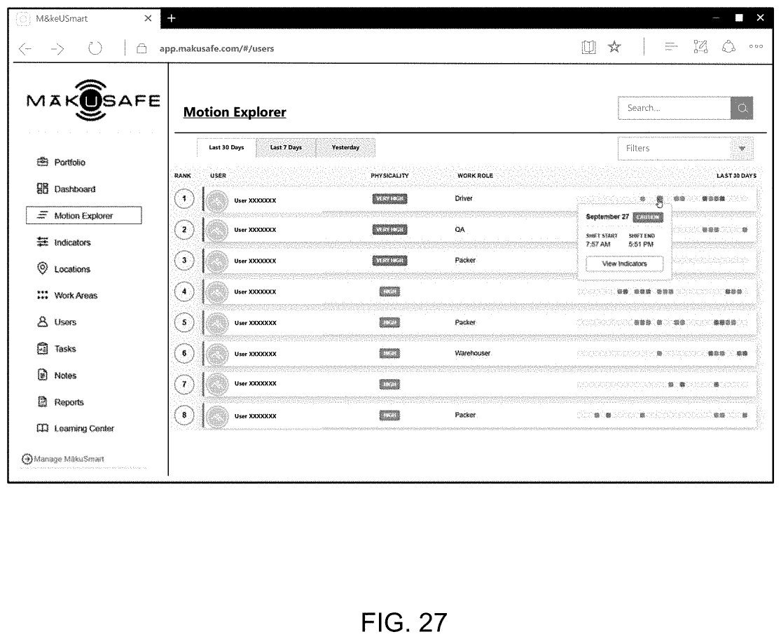

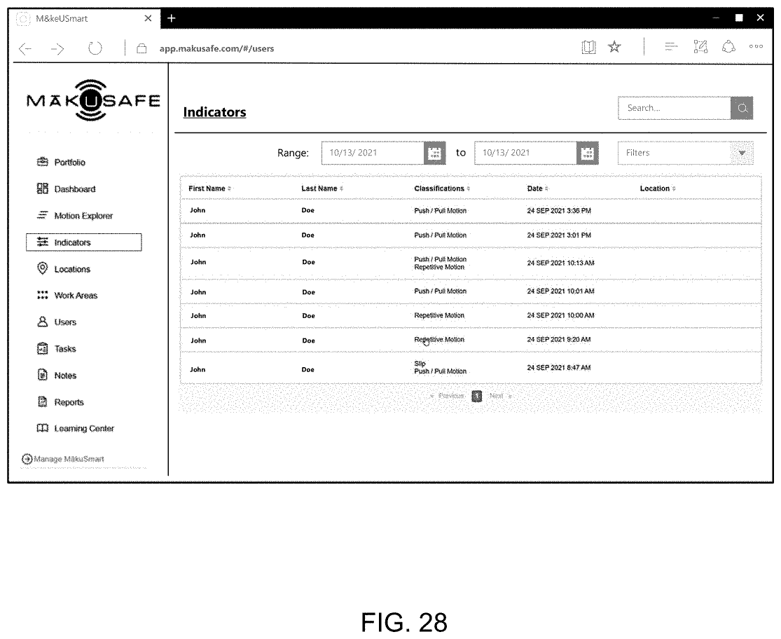

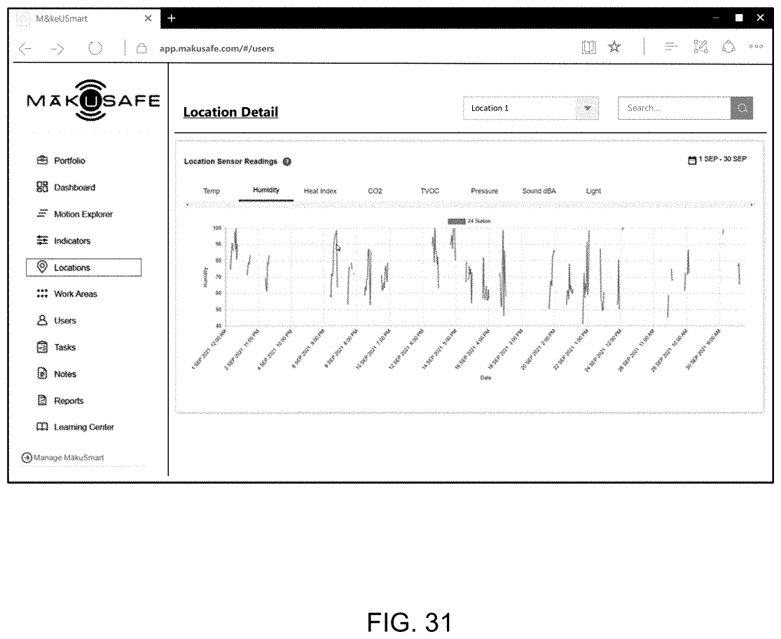

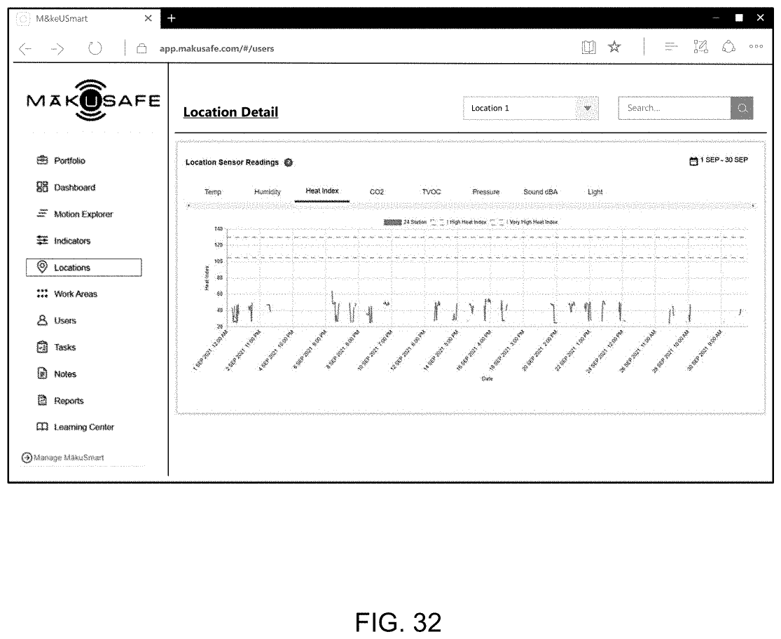

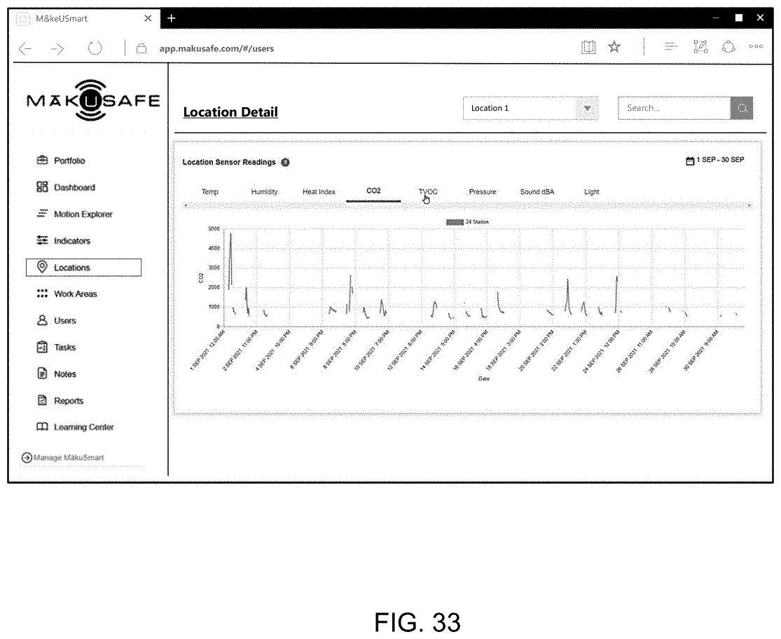

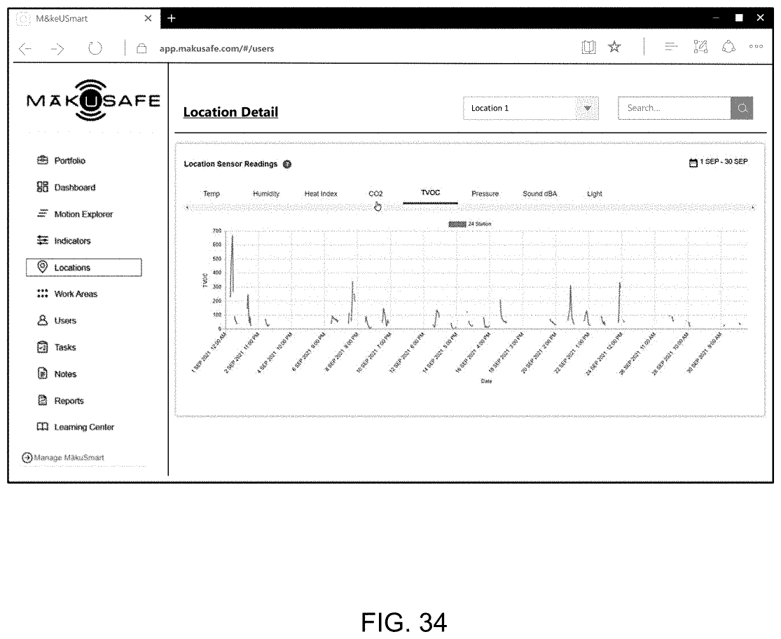

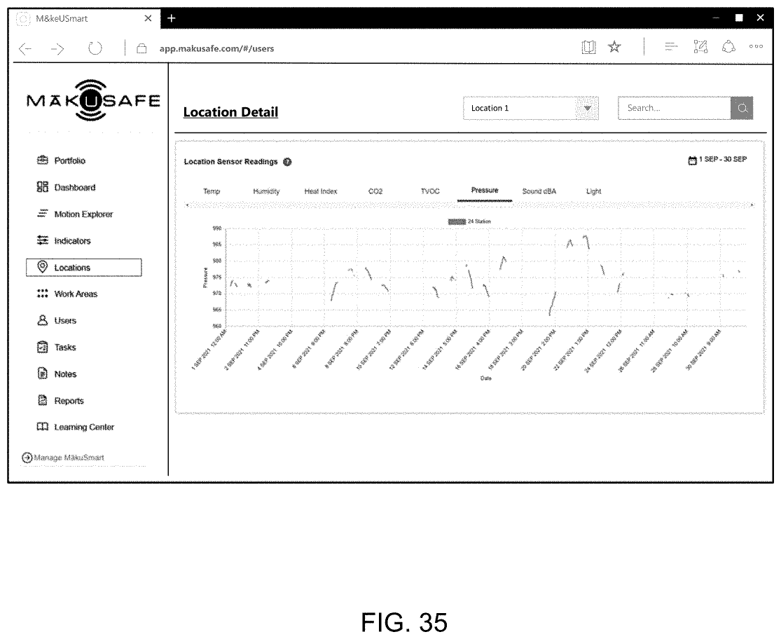

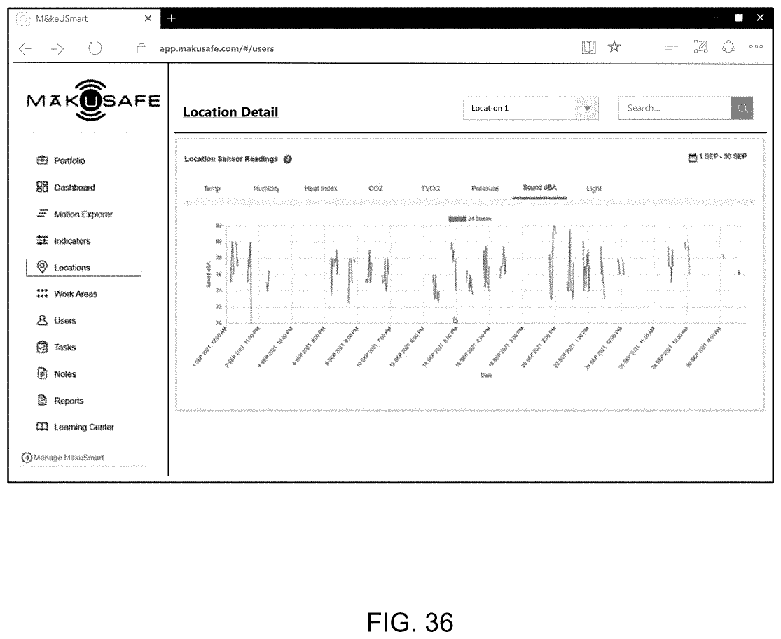

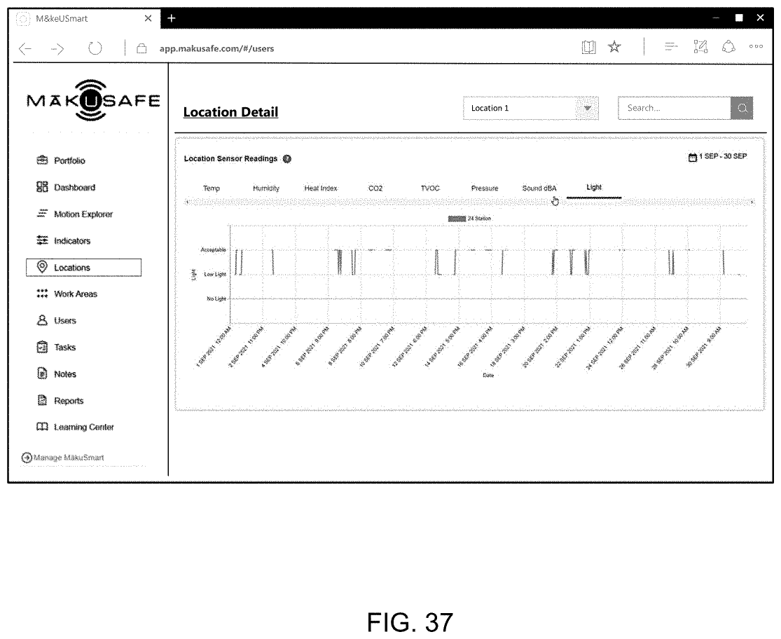

In one or more arrangements, policy management software 88 and/or other processes may be configured to provide a dashboard interface to facilitate review and/or evaluation of information and/or data metrics received from monitoring system 60 indicative of safety risks of faced by workers 102. FIGS. 24-39 show screen shots of an example user interface dashboard, consistent with one or more arrangements. In this illustrative example, user interface dashboard provides a number of various different tools to facilitate review and/or evaluation of information and/or data metrics received from monitoring system 60.

FIG. 24 shows an example “Users” tool provided by user interface dashboard that is configured to provide information for individual workers 102. In this example, the Users tool facilitates review of instances in which workers 102 are identified as performing specific work roles. In this example, each displayed instance indicates a worker 102, the work role that the worker 102 was identified as performing, the site at which the worker 102 was located, the date and time the worker was performing the identified work role, and the current status of the worker. In this example, the Users tool includes a search bar to permit a reviewer to search for identified work role instances for a particular worker. Such tool may be useful, for example, to facilitate audit of a policy for a particular worker 102 to determine if work roles declared by a company for a worker 102 accurately reflect the work roles that the worker 102 performs.

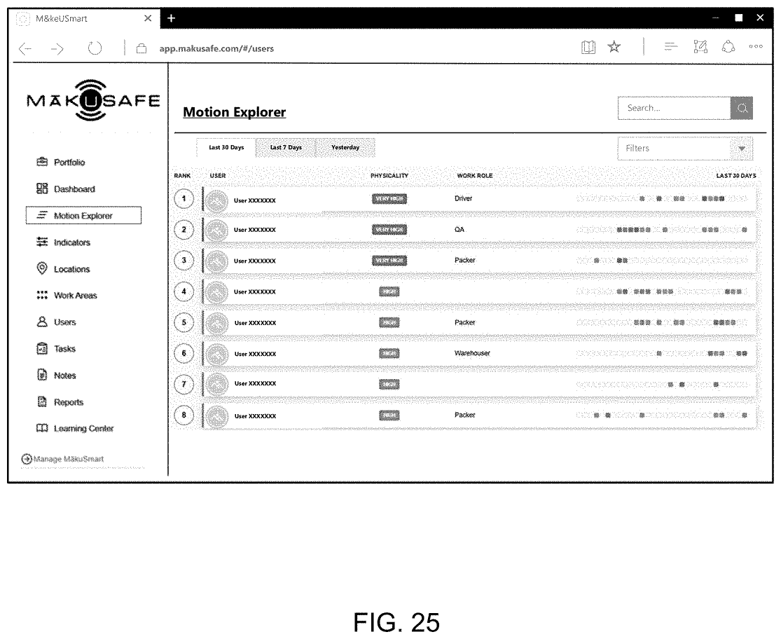

FIGS. 25-27 shows an example “Motion Explorer” tool provided by user interface dashboard configured summarize location based risk of workers 102 over a period of time. In this example arrangement, the Motion Explorer tool allows a user to review a summary of location based risk encountered by workers 102 in various time periods. In this particular example, a user may select to review location based risk data for the last 30 days, the last 7 days, or the previous day. However, the embodiments are not so limited. Rather, it is contemplated that in some various arrangements, the Motion Explorer tool may be configured to provide review of based risk data of workers 102 in any time period.

In this example arrangement, the Motion Explorer tool indicates for each worker a physicality level exhibited by the worker 102, the primary work role performed by the worker 102 (if identified), and a timeline that summarizes location based risk encountered by the worker 102 in the relevant period. In this example arrangement, workers 102 are ranked by the overall level of risk encountered and displayed in ranked order. Such ranking may be useful, for example, to facilitate identification and review of workers 102 that that have the greatest potential for workplace injury. However, the embodiments are not so limited. Rather, in this example arrangement the Motion Explorer tool permits a user to select criteria to filter and/or sort users of interest.

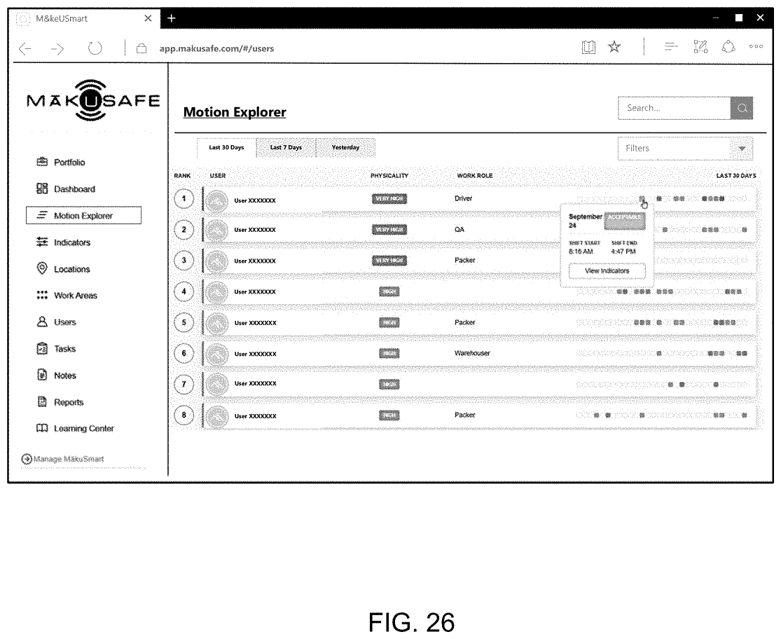

In this example arrangement, the timeline includes a series of blocks representing days of the selected period. In this example arrangement, blocks in the timeline are color coded to indicate the level of risk encountered (with darker colors indicating more risk). As shown in FIG. 26, in this example arrangement, when a user hovers the cursor over one of the blocks in the timeline, a popup window appears that provides additional detail relating to the risk determination. In this example arrangement, the popup window includes a button permitting a user to view the indicators that affected the risk determination. In response to, a user selecting the button, the user interface dashboard displays an Indicators tool.

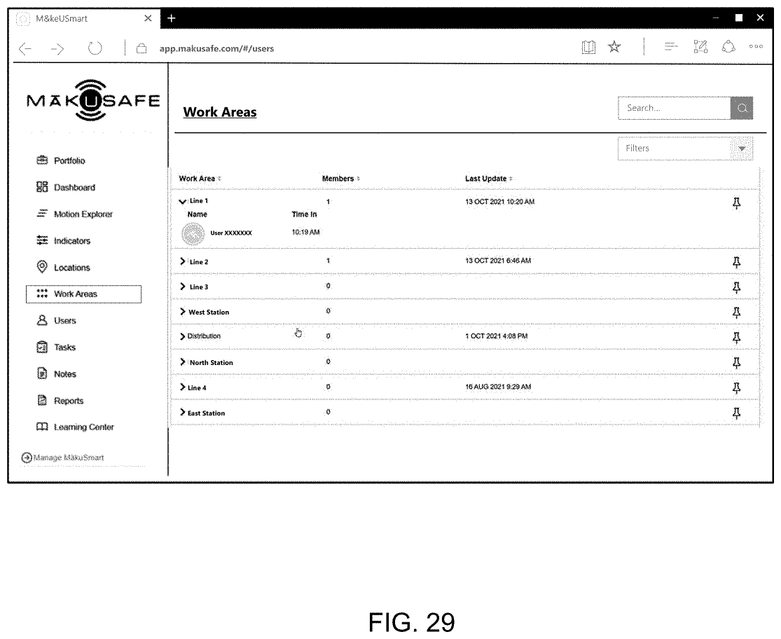

FIG. 28 shows an example “Indicators” tool provided by user interface dashboard configured facilitate review of identified indications of worker risk (indicators) over a period of time. When the Indicators tool is displayed in response to a user selecting the button of the popup window of the Motion Explorer tool, the Indicators tool shows indicators for the day that was selected by the user. However, in one or more arrangements, the Indicators tool may be configured by user to search for indicators in any specified time period. Furthermore, in this example arrangement, the Indicators tool permits a user to select criteria to filter and/or sort matching indicator records.

FIG. 29 shows an example “Work Areas” tool provided by user interface dashboard configured to facilitate review of workers 102 present in each work area in a specified period of time. In this example arrangement, the Work Areas tool provides collapsible lists of workers 102 determined to be located in each work area. In this example arrangement, the Work Areas tool lists workers 102 present in each work area along with the time at which the worker 102 was detected to be present in the work area. In this example arrangement, the Work Areas tool permits a user to select criteria to filter and/or sort worker entries and/or work areas displayed.

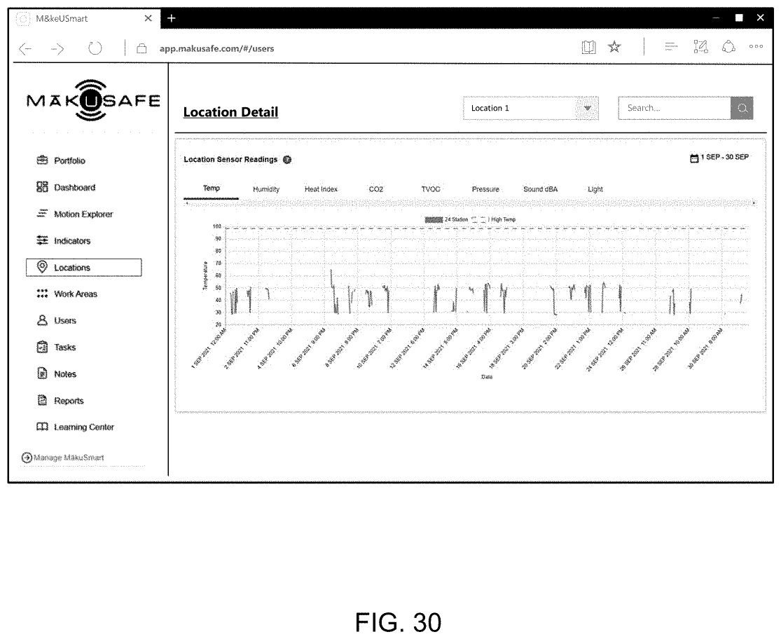

FIGS. 30-39 shown an example “Location Detail” tool provided by user interface dashboard configured to facilitate review of data gathered by monitoring system 60 in various different locations. As shown in FIGS. 30-37, in this example arrangement, the Location Detail tool includes a number of Tabs for display of data recorded by various sensors in a location and time period selected by a user. In this example arrangement, Tabs are available for display of temperature, humidity, heat index, CO2, TVOC, pressure, sound levels, and light levels. Such data may be useful to facilitate identification and evaluation of environmental risks presented in a location of interest.

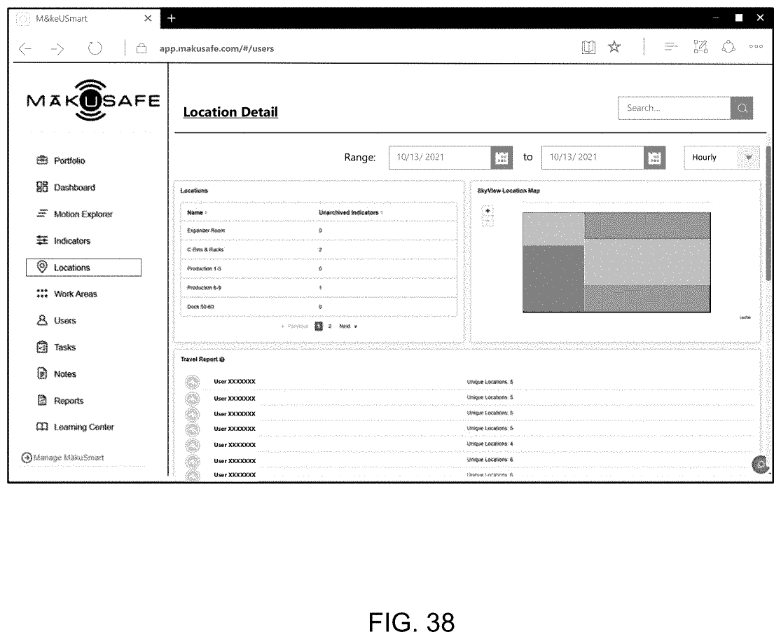

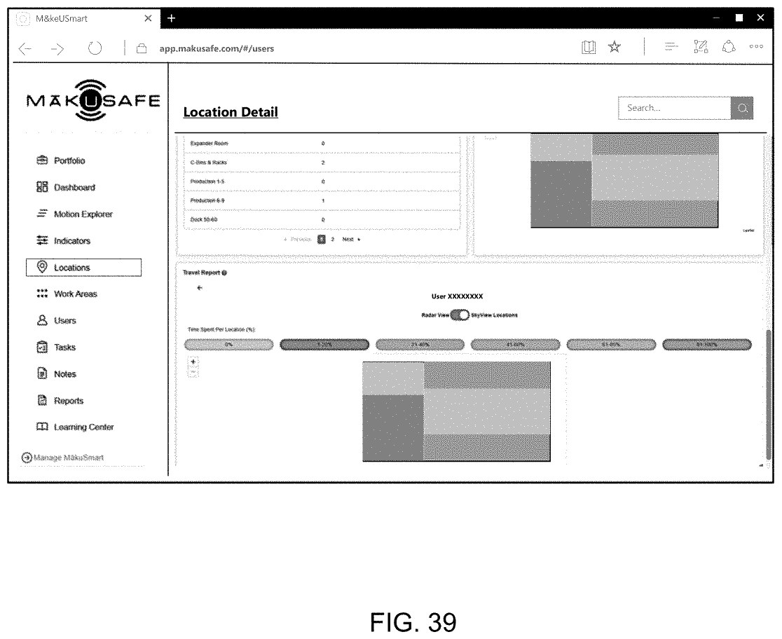

In one or more arrangements, the Location Detail tool is configured to facilitate review history of worker 102 travel in different areas of a location various locations for a selected period of time. FIG. 38 shows a summary risk indicators and travel of workers in different locations in a selected period of time. In this example arrangement, the Location Detail tool indicates risk indicators that were identified in the different locations within the selected time period. In this example arrangement, the Location Detail tool also displays a map of the locations to facilitate easy selection and review of data for specified locations (e.g., as shown in FIGS. 30-37. In this example arrangement, the Location Detail tool also displays a travel report for workers 102. In this example arrangement, the travel report indicates the number of unique locations visited by each worker 102 within the selected time period. In this example arrangement, the travel report ranks the users by the number of locations visited. Such ranking may be useful, for example to facilitate identification of workers 102 that visit many locations and thus are more likely to have overall risk that differs from a general risk for the workers 102 primary occupation or primary work station. In this example arrangement, a user may select a specific user in the travel report to show a map summarizing travel of the worker, for example, as shown in FIG. 39. In the example map shown in FIG. 39, areas are color coded to indicate percentage of time the selected worker spent in each location in the selected time period.

However, the embodiments are not limited to the example user interface dashboard and tools shown in FIGS. 24-39. Rather, it is contemplated that system 10 may utilize any type of user interfaces, which may present data in any format or form, to facilitate review and evaluation of data gathered by monitoring system 60.

Machine Learning:

In one or more embodiments, data processing systems 70 and/or 82 and/or other components of system 10 may be configured and arranged to monitor, learn, and modify one or more features, functions, and/or operations of the system. For instance, data processing system 70 and/or 82 may be configured to monitor and/or analyze data stored in database 68 and/or operation of system 10. As one example, in one or more arrangements, data processing systems 70 and/or 82 may be configured to analyze the data and learn, over time, data metrics indicative of different activities or tasks that may be performed by workers 102 in addition to their primary duties during a work shift. Such learning may include, for example, generation and refinement of classifiers and/or state machines configured to map input data values to outcomes of interest or to operations to be performed by the system 10. In various embodiments, analysis by the data processing system 70 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof.

From the above discussion, it will be appreciated that one or more arrangements provide a wearable device, system, and/or method of use presented improves upon the state of the art. Specifically, one or more arrangements provide a wearable device, system, and/or method: for collecting, reporting and analyzing information indicative of work performed by workers 102 and/or conditions that workers 102 are exposed to in a workplace to better assess risk posed to workers 102 through an entire work shift; that improves upon the state of the art; that collects information about the work performed by workers 102 and workplace conditions; that utilizes collected information to assess safety risks faced during a work shift; that aggregates a great amount of information about the work performed by workers 102 and workplace conditions; that eliminates bias in the collection of information about the work performed by workers 102 and workplace conditions; that eliminates the inconsistency in reporting information about the work performed by workers 102 and workplace conditions; that analyzes data gathered to assess risk posed to workers 102 at multiple times throughout a work shift; that more accurately assesses risk during a work shift; that determines insurance premium based on accumulated data indicative of work performed by workers 102 and workplace conditions; that aggregates a great amount of information indicative of work performed by workers 102 and workplace conditions to facilitate data analytics; that assesses gathered data indicative of work performed by workers 102 and workplace conditions to facilitate assessment of safety risks faced by workers during a work shift; that assesses gathered data indicative of work performed by workers 102 and workplace conditions to facilitate determination of work workers' compensation policy premiums; that assesses gathered data indicative of work performed by workers 102 and workplace conditions to facilitate end of year auditing of a workers' compensation policy; that gathers information indicative of work performed by workers 102 and workplace conditions without substantially inconveniencing workers; that is cost effective; that is safe to use; that is easy to use; that is efficient to use; that is durable; that is robust; that can be used with a wide variety of manufacturing facilities; that is high quality; that has a long useful life; that can be used with a wide variety of occupations; that provides high quality data; that provides data and information that can be relied upon; that allows for companies to compare the safety of their facilities to other facilities inside the same company and outside the company to determine how safe their facilities are in comparison; and/or that monitors physical exertion exhibited by workers during a work shift, among countless other advantages and improvements.

These and countless other objects, features, or advantages of the present disclosure will become apparent from the specification, figures, and claims.

What is claimed:

1. A system for assessing safety risk of a worker, comprising;
a wearable device;
the wearable device having a power source, a wireless communication module and at least one sensor;
wherein the wearable device records information indicative of work performed by a worker and working conditions;
a database;
the database configured to receive and store the recorded information;
a data processing system;
the data processing system communicatively connected to the database;
the data processing system configured to perform data analytics on the recorded information to identify safety risks faced by the worker during the work shift.

2. The system of 1, wherein the wearable device is configured to record the information in a plurality of time periods of the work shift;
wherein the data processing system is further configured to perform the data analytics on the information to identify safety risks to the worker in each of the plurality of time periods.

3. The system of 1, wherein the data processing system is further configured to generate a report indicating the identified safety risks and communicate the report over the internet to an insurer system.

4. The system of 1, wherein the wearable device is configured to record the information in a plurality of time periods of the work shift;
wherein the data processing system is further configured to perform the data analytics on the information to classify a type of work performed in each of the plurality of time periods.

5. The system of 1, wherein the wearable device is configured to record the information in a plurality of time periods of the work shift;
wherein the data processing system is further configured to perform the data analytics on the information to classify the type of work performed in each of the plurality of time periods;
wherein the data processing system is further configured to determine a risk level for each classification of the type of work performed in each of the plurality of time periods; and.
wherein the data processing system is further configured to determine an overall risk for the worker based on the determined risk levels.

6. The system of 1, wherein the system includes a plurality of wearable devices configured to record location of a plurality of workers throughout the work shift; and
wherein the data processing system is configured to determine a risk level for each of the plurality of workers based on location of the workers during the work shift.

7. The system of 1, wherein the data processing system is configured to perform the data analytics on the recorded information to identify accidents, trips, falls, or near misses that occur during the work shift of the worker;
wherein the data processing system is further configured to generate a report indicating the identified accidents, trips, falls, or near misses and communicate the report over the internet to an insurer system.

8. The system of 1, wherein the data processing system is configured to perform the data analytics on the recorded information to identify repetitive motions of the worker; and
wherein the data processing system is further configured to generate a report indicating the identified repetitive motions and communicate the report over the internet to an insurer system.

9. The system of 1, wherein the recorded information includes biometric measurement data of the worker;
the data processing system is configured to perform the data analytics on the biometric measurement data to determine a physicality rating of the work performed by the worker; and
wherein the data processing system is further configured to generate a report indicating the determined physicality rating and communicate the report over the internet to an insurer system.

10. A system, comprising;
a wearable device;
the wearable device having a power source, a wireless communication module and at least one sensor;
wherein when the wearable device is worn by a worker during a work shift, the wearable device records information indicative of work performed by the worker and working conditions;
a monitoring system;
the monitoring system configured to receive and store the recorded information;
a policy management system;
the policy management system communicatively connected to the monitoring system;
the policy management system configured to determine an insurance premium for the worker based on the recorded information stored in the monitoring system.

11. The system of 10, wherein the wearable device is configured to record the information in a plurality of time periods of the work shift; and
the policy management system configured to determine an insurance premium for the worker based on the information recorded from each of the plurality of time periods.

12. The system of 10, wherein the monitoring system includes:
a database;
the database configured to receive and store the data from the one or more sensors recorded by the wearable device;
a data processing system;
the data processing system communicatively connected to the database;
the data processing system configured to perform one or more data analytics processes to identify safety risks faced by the worker during the work shift.

13. The system of 10, wherein the monitoring system includes:
a database;
the database configured to receive and store the data from the one or more sensors recorded by the wearable device;
a data processing system;
the data processing system communicatively connected to the database;
the data processing system configured to determine a safety risk level for the worker based on the data recorded by the wearable device.

14. The system of 10, wherein the wearable device is configured to record the information in a plurality of time periods of the work shift;
wherein the monitoring system is further configured to perform data analytics on the information to identify safety risks to the worker in each of the plurality of time periods; and
the policy management system configured to determine an insurance premium for the worker based on the safety risks identified by the monitoring system in each of the plurality of time periods.

15. The system of 10, wherein the wearable device is configured to record the information in a plurality of time periods of the work shift;
wherein the policy management system is further configured to retrieve the recorded information from the monitoring system;
wherein the policy management system is further configured to perform data analytics on the recorded information to identify safety risks to the worker in each of the plurality of time periods; and
the policy management system configured to determine an insurance premium for the worker based on the safety risks identified by the monitoring system in each of the plurality of time periods.

16. The system of 10, wherein the wearable device is configured to record the information in a plurality of time periods of the work shift;
wherein the monitoring system or policy management system is further configured to perform data analytics on the information to classify a type of work performed in each of the plurality of time periods; and
the policy management system configured to determine an insurance premium for the worker based on the classification of the type of work performed in each of the plurality of time periods.

17. The system of 10, wherein the system includes a plurality of wearable devices configured to record location of a plurality of workers throughout the work shift; and
wherein the monitoring system or policy management system is configured to perform data analytics on the recorded information to identify higher risk areas and lower risk areas of a workplace;
wherein the policy management system configured to determine an insurance premium for the plurality of workers based on location of the workers during the work shift and the identified higher risk areas and lower risk areas.

18. The system of 10, wherein the monitoring system or policy management system is configured to perform data analytics on the recorded information to identify accidents, trips, falls, or near misses that occur during the work shift of the worker;
the policy management system configured to determine an insurance premium for the worker based on the identified accidents, trips, falls, or near misses.

19. The system of 10, wherein the monitoring system or policy management system is configured to perform data analytics on the recorded information to identify repetitive motions of the worker; and
the policy management system configured to determine an insurance premium for the worker based on the identified repetitive motions or the worker.

20. The system of 10, wherein the recorded information includes biometric measurement data of the worker;
the monitoring system or policy management system is configured to perform data analytics on the biometric measurement data to determine a physicality rating of the work performed by the worker; and
the policy management system configured to determine an insurance premium for the worker based on the determined physicality rating.

21. The system of 10, wherein the monitoring system or policy management system is configured to perform data analytics on the recorded information to identify safety risks faced by the worker during the work shift;
wherein the policy management system is configured to determine a base insurance premium based on an income of the worker and a primary occupational role of the worker;
wherein the policy management system is configured to determine an increase to the base insurance premium based on the identified safety risks faced by the worker;
wherein the policy management system is configured to determine a further increase to the base insurance premium based on a claims history of an employer of the worker.

22. The system of 10, wherein the wearable device configured to be attached to a worker during a work shift.

23. The system of 10, wherein the wearable device configured to be carried by a worker during a work shift.

24. A system, comprising;
a wearable device;
the wearable device having a power source, a wireless communication module and at least one sensor;
wherein the wearable device records information indicative of work performed by a worker and working conditions;
a database;
the database configured to receive and store the recorded information;
a data processing system;
the data processing system communicatively connected to the database;
the data processing system configured to determine an insurance premium for the worker based on the recorded information stored in the database.

25. The system of 24, wherein the wearable device is configured to record the information in a plurality of time periods of the work shift; and
the data processing system configured to determine an insurance premium for the worker based on the information recorded from each of the plurality of time periods.

26. The system of 24, wherein the wearable device is configured to record the information in a plurality of time periods of the work shift;
wherein the data processing system is further configured to perform data analytics on the information to identify safety risks to the worker in each of the plurality of time periods; and
the data processing system configured to determine an insurance premium for the worker based on the safety risks identified by the data processing system in each of the plurality of time periods.

27. The system of 24, wherein the wearable device is configured to record the information in a plurality of time periods of the work shift;
wherein the data processing system is further configured to retrieve the recorded information from the database;
wherein the data processing system is further configured to perform data analytics on the recorded information to identify safety risks to the worker in each of the plurality of time periods; and
the data processing system configured to determine an insurance premium for the worker based on the safety risks identified by the data processing system in each of the plurality of time periods.

28. The system of 24, wherein the wearable device is configured to record the information in a plurality of time periods of the work shift;
wherein the data processing system is further configured to perform data analytics on the information to classify a type of work performed in each of the plurality of time periods; and
the data processing system configured to determine an insurance premium for the worker based on the classification of the type of work performed in each of the plurality of time periods.

29. The system of 24, wherein the system includes a plurality of wearable devices configured to record location of a plurality of workers throughout the work shift; and
wherein the data processing system is configured to perform data analytics on the recorded information to identify higher risk areas and lower risk areas of a workplace;
wherein the data processing system configured to determine an insurance premium for the plurality of workers based on location of the workers during the work shift and the higher risk area and the lower risk areas.

30. The system of 24, wherein the data processing system is configured to perform data analytics on the recorded information to identify accidents, trips, falls, or near misses that occur during the work shift of the worker;
the data processing system configured to determine an insurance premium for the worker based on the identified accidents, trips, falls, or near misses.

31. The system of 24, wherein the data processing system is configured to perform data analytics on the recorded information to identify repetitive motions of the worker; and
the data processing system configured to determine an insurance premium for the worker based on the identified repetitive motions or the worker.

32. The system of 24, wherein the recorded information includes biometric measurement data of the worker;
the data processing system is configured to perform data analytics on the biometric measurement data to determine a physicality rating of the work performed by the worker; and
the data processing system configured to determine an insurance premium for the worker based on the determined physicality rating.

33. The system of 24, wherein the data processing system is configured to perform data analytics on the recorded information to identify safety risks faced by the worker during the work shift;
wherein the data processing system is configured to determine a base insurance premium based on an income of the worker and a primary occupational role of the worker;
wherein the data processing system is configured to determine an increase to the base insurance premium based on the identified safety risks faced by the worker;
wherein the data processing system is configured to determine a further increase to the base insurance premium based on a claims history of an employer of the worker.
